(19) United States
(12) Patent Application Publication
(10) Pub. No.: US 2014/0073551 A1
(43) Pub. Date: Mar. 13, 2014

(54) CLEANING COMPOSITIONS COMPRISING STRUCTURED PARTICLES

(71) Applicant: The Procter & Gamble Company, Cincinnati, OH (US)

(72) Inventors: Paul R. MORT, III, Cincinnati, OH (US); Francisco PALLARES-GALVAN, Mexico City (MX); Jose Rodel Mabilangan CARAGAY, Newcastle-upon-Tyne (GB); Hiram Alejandro RUBALCAVA TAYLOR, Rio de Janeiro (BR)

(73) Assignee: The Procter & Gamble Company, Cincinnati, OH (US)

(21) Appl. No.: 14/022,279

(22) Filed: Sep. 10, 2013

Related U.S. Application Data
(60) Provisional application No. 61/699,282, filed on Sep. 10, 2012.

(51) Int. Cl. C11D 17/06

(52) U.S. Cl. CPC C11D 17/06
USPC 510/367; 510/445; 510/400; 510/394; 510/392

(57) ABSTRACT

The present invention relates to a cleaning composition, preferably a granular detergent product, comprising a structured particle, preferably in an agglomerated form, comprising a cleaning active and a silica-based structurant having a hydrated particle size distribution of no more than 30 wt % greater than 45 micrometers and a tapped bulk density of from about 200 g/L to about 300 g/L. Process for preparing the structured particle, and methods of use, are also disclosed.

### FIELD OF THE INVENTION

The present invention is in the field of cleaning compositions. In particular, it relates to a granular detergent product having a structured particle comprising a silica-based structurant, and a cleaning active, preferably in the form of a structured agglomerate. Processes for making and methods of using the granular detergent product are also encompassed by the present invention.

### BACKGROUND OF THE INVENTION

Rapid dissolution of cleaning actives is a desirable characteristic for cleaning compositions. In addition, it is also desirable for cleaning compositions to be stable, both chemically and physically, under storage and handling conditions relevant to their production, packing, shipping, commercial sales and consumer use. However, these two beneficial properties oppose one another, as highly stable cleaning compositions tend to resist rapid dissolution. A solution found in the prior art is to envelope the cleaning composition in a coating. An example of this is PCT Publication WO2010/122051, Chambers, J. G. et al., published on Oct. 28, 2010, which describes a coating around an active core to improve stability, but it also delays the dissolution and is generally undesirable for washing, particularly under certain wash conditions (e.g., quick wash cycles).

In addition, the current market demands are for cleaning products with improved environmental sustainability (e.g., compact sizing) and/or energy savings (e.g., cold-water wash) without negatively impacting cleaning performance. This of course brings additional challenges regarding delivery of: 1) efficient mass and volume compaction of products, especially granular products; and 2) suitable cleaning performance under high water hardness and/or cold-water wash conditions.

Mass and volume compaction means increasing both mass and volumetric concentration of cleaning actives in, such as, for non-limiting example, granular detergent particles of detergent products, resulting in a compact dose with smaller mass and volume. Other benefits include a more environmentally cost-efficient product and package, along with improved efficiency of products' commercial supply chain. Existing formulation strategies for compact detergent products may include the use of water hardness-tolerant cleaning actives, for reducing and/or eliminating the need for other actives, such as, for non-limiting example, builder chemistry, to reduce the overall mass and volume.

High water hardness and/or cold-water wash can stress cleaning compositions', particularly granular detergent products', requirements in two ways: 1) for a given cleaning active, dissolution performance typically can be slower in cold-water, and 2) cleaning actives that can work efficiently at lower temperatures and/or can be more water hardness-tolerant tend to be stickier and more difficult to stabilize, particularly in a dry granular form.

Historically, spray-drying has been a useful means to produce dry granular detergent compositions, particularly granular detergent products, having moderate levels of cleaning actives. Good practice in spray-drying technology can produce granular detergent products with cleaning actives with relatively fast dissolution profile over a range of wash conditions. However, spray-drying has practical limitations, such as, for non-limiting examples, limited compaction capability, and poor physical stability of the granular detergent products, especially when comprising more highly concentrated levels of cleaning actives, especially when the cleaning actives comprise surfactant, chelant and/or polymer compositions that are optimized for cold-water cleaning. Additionally, in certain wash habits (e.g., when the dosing is concentrated for automatic washing machine dispensers), spray-dried granular detergent products can be susceptible to incomplete dissolution and form lump-gel residues.

Alternatively, mechanical agglomeration processes have been used to make dry laundry detergent compositions, particularly granular detergent products, with more concentrated cleaning actives and/or higher product density. With proper agglomeration processing, the granular detergent products have been demonstrated to have good physical and chemical stability. Agglomerated products have been shown to have adequate dispersion and dissolution in context of some wash habits, such as, for non-limiting example, in extended wash cycles and/or in concentrated dosing such as in automatic washing machine dispensers. However, the dissolution of agglomerated products is typically too slow for hand-wash consumers using shorter washing times or quick wash cycles in automatic washing machines, especially in cold-water washing conditions. In addition, there are practical limitations in the degree of compaction that is possible with certain surfactant, chelant and/or polymer compositions made using conventional agglomeration processes. The limit of the actives′ loading capacity is determined by saturation of the agglomerate structure, the saturation being a function of the ratio of active to filler materials. As the ratio of active to filler material increases with compaction, the saturation limit may be exceeded. In summary, what is needed is a suitable structurant material that can extend the saturation limit. This is especially needed when using hygroscopic or otherwise sticky actives in compositions that are optimized for cold-water cleaning.

The prior art discloses some silica-based particles that may be useful for cleaning compositions, especially granular detergent products, in attempt to address some of these challenges.

For example, PCT Publication WO2010/117925, Hernandez, E., published on Oct. 14, 2010, describes a detergent composition comprising a particle comprising a silica neutralization product combined with at least approximately 15% adjunct salt by-product for increasing the carrying capacity of the final composition to approximately 200% based on weight. While WO '925 mentions that their particle sizes can vary, it fails to disclose any specify size ranges in order to mitigate against fabric residue deposition. Further, the neutralization reaction as disclosed in FIG. 1 is substantially complete (i.e., less than 1 wt % of alkali metal starting material), through the addition of sulfuric acid to sufficiently neutralize all of the alkali ions bounds to the silicate anion to generate the silica/alkali particles of their invention. As such, there are no remaining silicate-alkali and/or free alkali ions that could further increase the bulk density and/or improve the dissolution and dispersion profile of their particles.

PCT Publication WO2011/090957, Mort, P. R. et al., published on Jul. 28, 2011, describes a structured detergent particle comprising a silicate structurant with a cleaning active, whereby contact with a plasticizer will cause the structurant to undergo a glass transition to form a microstructure network stabilizing the actives. The requirement of a glass transition means that the silicate structurant must first have a crystalline structure that undergoes a transition to an amorphous (glassy) state during the particle-formation process. The structurant of the current application is a derivative of amorphous silica; ergo no glass transition can occur.

U.S. Pat. No. 3,886,079, Burke, O. W., granted on May 27, 1975, which discloses a detergent composition comprising of detergent adjuvant and cleaning actives. The detergent adjuvant is formed by the reaction of an alkali metal silicate solution with an alkali metal bicarbonate. In this case, the adjuvant comprises a silica neutralization product and a salt by-product, the salt comprising sodium carbonate. The structurant of the current application is formed by neutralization of silicate with sulfuric acid, forming sodium sulfate as an adjunct salt.

U.S. Pat. No. 6,369,020, Kohlus, R., et al., granted Apr. 9, 2002, describes detergent granules comprising heat-sensitive surfactant and water-insoluble silica material having a high oil absorption capacity and an additional film-forming structurant. However, the exemplified silica materials lack adjunct salt; such commercially-available silica is either prone to residue problems due to large aggregate size, or handling difficulties due to highly aerated bulk density when milled to a fine particle size.

Thus, there is a need for a cleaning composition, preferably a granular detergent product, to meet the current challenge in environmental sustainability and/or energy efficiency. There is also the need for a cleaning composition, preferably a granular detergent product, having sufficiently rapid dispersion and dissolution of the cleaning actives across a range of consumer wash habits.

The need also exist for a cleaning composition, preferably a granular detergent product, to have physical and chemical stability across a range of manufacturing, handling and storage conditions, and compact form having increased mass and volume concentration of cleaning actives.

It is desirable that the cleaning actives, in the above cleaning compositions, are preferably relevant to cold-water and/or hardness-tolerant wash conditions.

### SUMMARY OF THE INVENTION

In a first aspect, the present invention is directed to a cleaning composition, preferably to a granular detergent product, comprising a structured particle, wherein the structured particle comprises: (a) from at least 10 wt % of a cleaning active, selected from the group comprising of: a surfactant, a chelant, a polymer, an enzyme, a bleaching active, a perfume, a hueing agent, a silicone and any mixture thereof, preferably a surfactant, a chelant and a polymer; and (b) from about 1 wt % to about 40 wt % of a structurant.

Further, the structurant comprises: (i) from about 55 wt % to about 90 wt % of a silica having a [Na₂O]:[SiO₂] molar ratio of from about 0.02 to about 0.14, preferably from about 0.02 to about 0.10, more preferably from about 0.04 to about 0.08; and (ii) at least about 10 wt %, preferably at least about 15 wt % of an adjunct salt. The structurant further has a hydrated particle size distribution such that no more than 30 wt % of the structurant has a hydrated particle size greater than 45 micrometers according to the Structurant Residue Test Method described herein, and a tapped bulk density of, from about 200 g/L to about 300 g/L, preferably from about 200 g/L to about 280 g/L, more preferably from about 220 g/L to about 280 g/L.

In an embodiment, the structured particles of the present invention can provide for mass and volume compaction of the cleaning actives, while retaining adequate chemical and physical stability for handling and storage, but also providing for sufficiently rapid dispersion and dissolution over a range of wash habits, especially useful for cleaning in cold-water and/or high water hardness conditions. Therefore, the structured particles may increase the concentration of cleaning actives in the cleaning composition, and yet still maintain chemical and physical stability of the cleaning actives in the dry state.

In yet another aspect, the process for making the cleaning compositions, preferably the granular detergent products is disclosed. The process provides for adding structured particles having improved physical strength, for handling stability, as well as adequate porosity for accelerated dissolution. The combination of the structured particles' structure and formulation promotes rapid dissolution in wash water, preferably cold-water wash and/or high hardness water conditions, suitable for a broad range of consumer wash habits, even with product compaction, preferably at high compaction levels.

These and other features of the present invention will become apparent to one skilled in the art upon review of the following detailed description when taken in conjunction with the appended claims.

### BRIEF DESCRIPTION OF THE DRAWINGS

While the specification concludes with claims particularly pointing out and distinctly claiming the invention, it is believed that the invention will be better understood from the following description of the accompanying FIGURES wherein:

FIG. 1 shows the graph for the Saturation Capacity Test.

### DETAILED DESCRIPTION OF THE INVENTION

### Definitions

As used herein, the term “cleaning composition” includes, unless otherwise indicated, granular or powder-form all-purpose or “heavy-duty” washing agents, especially cleaning detergents; hand dishwashing agents or light duty dishwashing agents, especially those of the high-foaming type; machine dishwashing agents; mouthwashes, denture cleaners, car or carpet shampoos, bathroom cleaners; hair shampoos and hair-rinses; shower gels and foam baths and metal cleaners; as well as cleaning auxiliaries such as bleach additives or pre-treat types. In one preferred aspect, the cleaning composition is a laundry detergent composition, more preferably a solid laundry detergent composition, and most preferably a free-flowing particulate laundry detergent composition (i.e., a granular detergent product).

As used herein, the articles “a” and “an” when used in a claim, are understood to mean one or more of what is claimed or described.

As used herein, the term “active” or “cleaning active” can be used interchangeably and means any functional cleaning chemistry that can be used as part of the product of the invention. Suitable cleaning actives can include, but are not limited to, surfactants, chelants, polymers, enzymes, bleaching actives, anti-corrosion agents, care agents, perfumes, hueing agents, silicones, and any mixture thereof. Preferably, the cleaning active is a surfactant, a chelant, a bleach, an enzyme and/or a polymer. Preferably, the cleaning active is suitable for cold-water and/or high water hardness cleaning, and may be sticky and/or hygroscopic in nature.

As used herein, the term “cold-water” or “cold water” means washing at temperature ranges at the lower end of what is typically used for the cleaning compositions of the present invention, such as, for non-limiting examples, laundry and dish washing applications. Preferably, “cold water” means washing at lower temperatures than what is typically used for the cleaning compositions of the present invention. The “cold water” of the present invention can be washed at temperatures of from about 5° C. to about 40° C., or from about 20° C. to about 30° C., or from about 15° C. to about 25° C., as well as all other combinations within the range of about 15° C. to about 35° C., and all ranges within 10° C. to 40° C.

As used herein, the term “structurant” means an absorbent particulate material that is capable of imparting physical stability to a structured particle comprising a cleaning active, especially where the structured particle is made using, for non-limiting example, an agglomeration or layering process. In addition, the structurant has the ability to absorb the excess or residual water in dilute wash conditions, aiding in the rapid disintegration of the structured particle's structure in the wash context, and thereby accelerating the release of the cleaning active into the wash.

As used herein, the term “Saturation Capacity” means the ratio of an absorbed cleaning active relative to the mass of the structurant, as measured by the Saturation Capacity Test as described herein.

As used herein, the term “residue” means the mass of material that is retained as a residue on a screen, fabric or other material acting as a filter.

As used herein, the term “structurant residue” means the amount of residue associated with a structurant, as measured using the Structurant Residue Test as described herein.

As used herein, the term “structurant residue factor” is defined as the dry mass ratio of structurant residue relative to the initial solid structurant mass, as measured in the Structurant Residue Test as described herein.

As used herein, the term “agglomerate” means a particle comprising a composite of ingredients, optionally including an active. Further, the term “Structured agglomerate” means a particle where the structurant is included in the agglomerate structure.

As used herein, the term “stabilizer” means a material that is capable of imparting chemical stability to a cleaning active.

As used herein, the term “layer” means a partial or complete coating of a layering material built up on a structured particle's surface or on a coating covering at least a portion of the surface. Further, the term “structured layer” means a layer comprising a structurant and optionally an active.

As used herein, the term “seed” means any structured particle that can be coated or partially-coated by a layer. Thus, a “seed” may consist of an initial seed structured particle or a seed with any number of previous layers.

As used herein, the term “structured particle” means a particle comprising a structurant and a cleaning active, preferably a structured agglomerate, layered structured particle having a structured agglomerate seed, layered structured particle with a structured layer, or any combination thereof.

As used herein, the term “carrying capacity” means the ability of a dry material, such as, for non-limiting example a dry detergent composition, to use water or other liquids as a structural component. Carrying capacity also reflects the ability of the other dry material to be able to carry high amounts of water or other liquids and still behave as a solid powder. Typically, detergent compositions having a liquid content above 5% may experience decrease in quality since the excess liquid not used in any structural manner may cause the granules of the detergent to stick together.

As used herein, the term “water hardness” includes uncomplexed calcium (Ca²⁺) arising from water and/or soils on dirty fabrics; more generally and typically, “water hardness” also includes other uncomplexed cations (Mg²⁺) having the potential to precipitate under alkaline conditions, and tends to diminish the surfactancy and cleaning capacity of surfactants. Further, the term “high water hardness” is a relative term and for the purposes of the present invention, means at least “12 grams per gallon water (gpg, “American grain hardness” units) of calcium ion”.

It is understood that the test methods that are disclosed in the Test Methods Section of the present application can be used to determine the respective values of the parameters of Applicants' inventions as such inventions are described and claimed herein. Alternatively, other equivalent methods commonly known to those skilled in the art can be used.

### Cleaning Active

Advances in detergent formulations have been limited by constraints in processing and stabilization of cleaning actives such as ethoxylated alcohol-derived surfactants, chelants, active polymers, bleaching actives and enzymes. Liquid detergent formulations may be limited by the stability of active ingredients such as bleach and enzymes. In addition to stability limitations of actives, granular detergent formulations may be further constrained by the handling profile of particulates, particularly particulates comprising sticky or hygroscopic cleaning actives such as surfactant, chelant and/or polymer materials.

In one aspect, the cleaning active comprises anionic surfactant, preferably neutralized in the form of a sodium salt. The anionic surfactant may comprise an alkylalkoxysulfate, preferably sodium alkylethoxysulfate, (AES), wherein the average degree of alkoxylation, preferably ethyoxylation, is preferably in the range of about 0.1 to 5.0, preferably from about 1.0 to 3.0. The anionic surfactant may comprise linear-alkylbenzene-sulphonate (LAS). The anionic surfactant may comprise alkyl-sulfate (AS).

In another aspect, the cleaning active comprises non-ionic alkylalkoxylate surfactant, preferably ethyoxylate (AE), wherein the average degree of alkoxylation, preferably ethyoxylation, is preferably in the range of about 3 to 12, preferably from about 5 to 10.

In another aspect, the cleaning active comprises cationic surfactant.

In another aspect, the cleaning active comprises chelant. Suitable chelants include, but are not limited to, tetrasodium carboxylatomethyl-glutamate (Dissolvine® or GLDA), trisodium methylglycinediacetate (Trilon® M or MGDA), diethylene triamine pentaacetic acid (DTPA) or ethylenediamine tetraacetic acid (EDTA).

In another aspect, the cleaning active comprises water-soluble polymer. Suitable polymers include, but are not limited to, polymeric carboxylates, such as polyacrylates, poly acrylic-maleic co-polymers, and sulfonated modifications thereof. The polymer may be a cellulosic based polymer, a polyester, a polyterephthalate, a polyethylene glycol, a polyethyleneimine, any modified variant thereof, such as polyethylene glycol having grafted vinyl and/or alcohol moieties, and any combination thereof.

In another aspect, the cleaning active comprises polymers that are sparingly-soluble in water but may contribute to effective surfactancy and performance. Suitable polymers include, but are not limited to, sulphonated and unsulphonated PET/POET polymers, both end-capped and non-end-capped, and polyethylene glycol/polyvinyl alcohol graft copolymers such as Sokolan® HP222.

Structured particles comprising the cleaning actives may include one or more cleaning actives, and may be in the form of agglomerated or layered particle morphologies.

The cleaning actives of the current invention can be difficult to handle in a pure solid form; hence they may be processed in the form of liquid or paste raw materials. In one embodiment, the liquid or paste raw materials are aqueous solutions or, in the case of surfactant, aqueous mesomorphic phase materials. In another embodiment, the liquid raw materials are substantially non-aqueous liquids.

### Structurant

The structurant can efficiently absorb cleaning actives that are added to the structured particle-making process, but yet can also quickly release the same cleaning actives when contacted with water. Preferably, the structurants can absorb high levels of cleaning actives, and have a Saturation Capacity of greater than about 1.5, preferably greater than about 2.0, and more preferably greater than about 2.3.

The structurant of the current invention comprises amorphous silica, which can be made using any available methods. However, one specific method that may be particularly useful employs a controlled precipitation or sol-gel process, wherein alkaline silicate is neutralized with an acid in a dilute aqueous condition to make very fine particles, i.e. colloidal particles, of silica. The silica fine particles have particle size of less than about 40 micrometers, preferably less than about 30 micrometers, and even more preferably less than about 20 micrometers. The fine particles may associate together to form larger aggregates, i.e., micro-gels, in the aqueous suspension, where the aqueous phase of the suspension includes counter-ions of the neutralization reaction, i.e., a salt solution. The salt ions may be partially adsorbed onto the surface of the colloidal silica structure, for non-limiting example within a micro-gel. Any commonly known alkaline silicate can be used in the neutralization reaction, although the preferred alkaline silicate is sodium silicate, preferably with a [SiO₂]/[Na₂O] molar ratio of from about 2 to 3.4, and more preferably from about 3.0 to 3.2. The acids or acidification agents used in the neutralization reaction may include, for non-limiting example, CO₂, H₂CO₃, H₂SO₄, and NaHCO₃, preferably H₂SO₄.

Optionally, a portion of the salt solution may be separated and removed, for non-limiting example by filtration or centrifugation, forming a wet cake having a semi-solid network of colloidal silica imbibed with aqueous salt solution.

The suspension or wet cake is dried to form a powder having a composite structure, the composite structure having micron-scale discrete phases of amorphous silica aggregates and adjunct salt. The adjunct salt is formed primarily by crystallization of the aqueous salt solution on drying. Adjunct salt may be present within the aggregated structure of the colloidal silica, and can assist in the dispersion of aggregates when the added to water, for non-limiting example in a washing process. While not being bound by theory, it is expected that dispersion of silica aggregates in a detergent use context is facilitated by dissolution of the adjunct salt. Effective dispersion of silica aggregates reduces the incidence of residues on fabrics, for example, as measured in the Structurant Residue Test as described herein.

The product powder is the structurant of the current invention. Preferably, the structurant (i.e., powder) has from about 0% to 40% water, more preferably from about 2% to 20% water, most preferably from about 4% to 10% water, by total weight, retained after drying.

The extent of the neutralization reaction, converting silicate to silica, may be substantially complete, or preferably, partially complete. In the case of partial neutralization, an amount of alkali metal may remain in the amorphous silica phase of the structurant. In the amorphous silica phase of the structurant, the molar ratio of alkaline metal oxide, [M₂O] where M is in alkaline metal, preferably sodium, to silica [SiO₂] is from about 0 to about 0.14 or from about 0.02 to about 0.14, preferably from about 0.02 to about 0.10, more preferably from about 0.04 to about 0.08.

In contrast to the current invention, commercial silica processing commonly removes all of the alkali metal salt, but for some limited uses, such as in battery separators, where a salt content of 5-10%, particularly of sodium sulphate, may be permissible (see U.S. Pat. No. 5,871,867, Rausch et al., granted Feb. 16, 1999). However, the sulphate-containing precipitated silica disclosed in U.S. Pat. No. '867 has a pH value of 3.0 to 4.0, and would not be desirable since it would be harmful for acid-sensitive actives, such as for non-limiting examples, chelants, surfactants and enzymes. Thus, a desirable level of alkalinity is need for sufficient cleaning performance, particularly, without the need for costly addition of other ingredients (e.g., builders).

It was surprisingly discovered that the alkalinity of the structurant may correlate to the extent of the neutralization reaction. For example, reducing the amount of acid or acidulant in the neutralization reaction to levels that are less, preferably substantially less, than stoichiometric can result in a structurant having more alkali ions in the amorphous silica phase, thereby causing and/or contributing to higher alkalinity of the structurant. Therefore, it is expected that one may be able to adjust the alkalinity of the structurant by controlling the degree of neutralization. In an embodiment, a structurant with high alkalinity can have dual roles, acting both as a structural element with a high Saturation Capacity (i.e., carrying capacity) correlating to increase carrying capacity and as an alkaline stabilizer for acid-sensitive actives. Thus, it would be desirable to have structurants having relatively high alkalinity by not having complete neutralization. In an aspect of this embodiment, the structurant has a pH from about 8.5 to about 11.0, preferably from about 9.0 to about 10.5, and even more preferably from about 9.5 to about 10.0, according to the Structurant pH Test as described herein.

Further, the structurant made by neutralization of alkaline silicate with acid, preferably partial neutralization, can be optionally washed and filtered to remove a portion of the soluble alkaline salt by-product. Alternatively, the full suspension reaction product, including soluble salts formed as a by-product of silicate neutralization, may be dried to form the structurant, preferably in a powder formed.

The current accepted industry standards for making precipitated silica, i.e., that is silica produced by substantially complete neutralization reaction, includes filter and wash steps to remove salt by-products from the end product. However, the applicants find that by not removing the salt by-products, either fully or partially, the salts can be useful as adjuncts for detergent processing.

In particular, the structurant of the present invention, which can be made with at least about 10 wt %, preferably at least about 15 wt % of adjunct salt, can provide suitable structuring in terms of Saturation Capacity while also having good dispersibility and a significantly higher tapped bulk density compared to commercial silica. For non-limiting example, commercial silica, which has no alkali metal salts, typically has a bulk density of from about 100 g/L to about 150 g/L. There are specialty silica/alkali metal particles having a tap bulk density of about 300 g/L (see PCT Publication WO2010/117925), however, while bulk density is an important parameter for processability reasons, other properties (e.g., porosity, particle size distribution, etc.) of the structurant must also be controlled to maximize overall performance.

In one embodiment, the structurant with at least 10 wt %, preferably at least 15 wt % adjunct salt, has a tapped bulk density of from about 200 g/L to about 400 g/L, or from about 200 g/L to about 300 g/L, or from about 230 g/L to about 350 g/L, preferably from about 200 g/L to about 280 g/L, and more preferably from about 220 g/L to about 280 g/L.

Of note is that the increase in bulk density correlates well with the processability of the ingredient, preferably, with ease of handling of the powder material in an industrial process, such as, for non-limiting example, a detergent granulation process.

To the extent that the structurant is relatively insoluble in wash water conditions, the structurant must also be capable of sufficiently rapid dispersion from a structured agglomerated state into a finely-divided state, and passing through a fine-mesh screen. Preferred structurants of the present invention have a Structurant Residue Factor (RF) of less than about 0.5, preferably less than about 0.3, more preferably less than about 0.1, and even more preferably less than about 0.05, according to the Structurant Residue Test as described herein. While not wishing to be bound by theory, it is expected that the presence of adjunct salt in a concentration of at least about 10 wt %, preferably at least about 15 wt % provides a means to further aggregate the fine silica or silicate particles, increasing their bulk density and improving the handling of the structurant powder; while at the same time, the solubility of the salt-bound aggregates provides excellent dispersion of the aggregates in wash-conditions, effectively mitigating risk of fabric residues. The Structurant Residue Factor correlates well with the products' propensity of leaving residue on fabrics, for example, when the structurant is a component of a structured particle, and the structured particle is used in a cleaning composition, preferably a granular detergent product.

### Structured Particle

In one embodiment, the structured particle comprises a cleaning active, a structurant and optionally a stabilizer. In one aspect, the structured particle may be formulated in a granular or powder cleaning product. In another aspect, the structured particle may be formulated as a particulate suspended in a liquid matrix. In another aspect, the structured particle may be formulated in a unit dose detergent, either in a granular or powder matrix, as a particulate suspended in a liquid matrix, or as a particulate embedded in a soluble film.

Product advantages include formulation of cleaning actives in a particle form with chemical and physical stability suitable for use in fully formulated detergent products. Especially preferred are actives that are effective in cold-water detergency and which may be difficult to process and/or stabilize physically and/or chemically using conventional detergent particle-formation methods such as agglomeration or spray-drying. Preferred actives include but are not limited to hygroscopic actives (e.g., chelants, water-soluble polymers), actives whose raw material precursor is in the form of a liquid solution, paste or suspension (e.g., surfactant pastes, surfactant solutions, polymer solutions, chelant solutions), and actives whose dried form has a soft solid or sticky paste consistency (e.g., ethoxylated surfactants).

The cleaning active is preferably selected from detersive surfactant, chelant, detersive polymer, water-soluble polymer and any combination thereof.

The process advantages of using a suitable structurant include simplified processing of detergent particles, especially those comprising preferred cleaning actives outlined above, where conventional particle processing methods are difficult or practically unfeasible in the context of formula compaction. Simplified processes may include, but are not limited to agglomeration, spray-drying, gelation, extrusion, extraction, and prilling.

The structure particle comprises at least 10 wt %, 15 wt %, 25 wt %, 30 wt %, or preferably at least 35 wt %, more preferably at least 40 wt %, or at least 45 wt %, or at least 50 wt %, or at least 55 wt %, or even at least 60 wt %, or even 65 wt % cleaning active. Preferably, the structured particle comprises to 95 wt %, or to 90 wt %, or to 80 wt %, or even to 70 wt % cleaning active. The concentration of actives in the structured particle is achieved in proportion to the concentration of the active in its raw material (e.g., as a solution or paste), the amount of structurant used, and the Saturation Capacity of the structurant with respect to the active raw material.

The particle comprises structurant from about 1 wt % to about 40 wt %, preferably from about 5 wt % to about 25 wt %, or from about 10 wt % to about 20 wt %.

In addition to the active concentration, the current invention provides for chemical stabilization of the concentrated actives in the structured particle. In the case of neutralized ionic surfactant, chelant, and/or polymer, a stabilizer may be used to stabilize the active composition. A suitable stabilizer provides a chemical buffer, preventing significant reversion and/or hydrolysis of the active. The requirement of a stabilizer is especially relevant to anionic surfactants, especially alkylalkoxysulfate types, preferably sodium alkylethoxysulfate, (AES). In one aspect of an anionic surfactant, the stabilizer is an alkaline metal carbonate, preferably sodium carbonate, preferably finely-divided sodium carbonate having a D50 particle size <about 50 μmm, preferably <about 30 μm, and more preferably <about 20 μm, where the stabilizer is intimately mixed with the active within the structured particle. In another aspect, the stabilizer is an alkaline metal hydroxide, preferably sodium hydroxide, where the stabilizer is intimately mixed with the active within the structured particle, for example by pre-mixing a caustic solution with the surfactant raw material, or for example by mixing the caustic solution with the active and structurant in an agglomeration process or layering process. In another aspect, the stabilizer may be inherently part of the structurant material, for example as an alkaline silicate.

The amount of stabilizer required depends on the type of stabilizer and the type of active; typically it is desirable to minimize the amount of stabilizer, using only as much as need for chemical stability. While not being limited to theory, it is expected that excessive use of chemical stabilizers can have a negative effect on the actives' rate of dissolution in the wash context. In the aspect of sodium AES surfactant, stabilized with finely-divided sodium carbonate in an agglomerate structure, the preferred molar ratio of stabilizer to surfactant is from about 1 to 5, preferably from about 2 to 4. In the aspect of sodium AES surfactant stabilized with sodium hydroxide solution, in a liquid-liquid premix, the preferred molar ratio of stabilizer to surfactant is from about 0.05 to about 0.5, preferably from about 0.1 to 0.3.

The preferred structured particle has a balance of strength and porosity. Surprisingly, the strength of well structured particles having high active concentrations can exceed the strength of lower-active particles without structurants, even with soft or sticky actives, even with marginally higher porosity in the structured agglomerates, and even under more humid environmental conditions. The higher dry strength of structured particles versus conventional agglomerates provides improved physical stability for handling and storage of the granular detergent product.

In an embodiment, the structured particle has a Physical Stability of greater than about 0.6, or even greater than about 0.8, as measured using the Physical Stability Test method as described herein. Preferably, the structured particle when initially equilibrated to ambient conditions of from 30% relative humidity and temperature of about 22° C., and then exposed in an open container for 24 hours to conditions of (i) environmental relative humidity of 74%, and (ii) a temperature of about 32° C., retains a flowability, as measured using the Flowability Test as described herein, of at least 4, preferably at least 5, or at least 6, or at least 7, or at least 8, or at least 9, or even at least 10. Further, the particle may be hygroscopic, wherein it has a weight gain of greater than about 3 wt %, 6 wt % or even 10 wt % during the exposure period, and it retains a flowability of at least 4.

In one aspect, structured particles have a bulk density of about 500 g/L to 800 g/L, preferably from about 600 g/L to 700 g/L. The range of porosity of the structured particles is from about 5% to about 30%, preferably from about 10% to about 25%, as measured using the Porosity Test as described herein.

When immersed in wash water, the higher porosity of structured particles versus conventional agglomerates provides more rapid disintegration of the particles and dissolution of cleaning actives. The presence of structurant in an intimate mix with actives further provides for even more rapid disintegration of particles and rapid dissolution of actives. Without being bound by theory, it is hypothesized that the structurant can act as a means to rapidly imbibe wash water into the internals of the structured particle, promoting more rapid softening and disintegration of the particle, as well as faster dissolution of actives.

The particle size distribution of structured particles is preferably well characterized as an approximate log-normal distribution having a D50 median of from about 250 μm to 600 μmm, preferably from about 300 μm to 500 μm, and a distribution span of from about 1.0 to about 2.3, preferably from about 1.1 to 2.0, most preferably from about 1.2 to 1.7.

In contrast to layered particles having a protective layer surrounding an active core, the core comprising a hygroscopic or otherwise sticky active (for example, see PCT Publication WO2010/122051), the current invention allows for the formulation of hygroscopic and/or sticky actives in the outer layer. This is especially advantageous when the actives (for non-limiting example AES) are suitable for cleaning in cold-water and/or high hardness wash water conditions. The presence of the actives in the layer promotes the initial dissolution of the cold-water and/or hardness-tolerant chemistry. While not being bound by theory, it is hypothesized that having cold-water and hardness-tolerant chemistries earlier in the order of dissolution can protect the more conventional cleaning actives (for non-limiting example LAS surfactant), resulting in superior overall cleaning performance.

### Process for Making a Structured Particle

The process of making the structured particle, preferably in an agglomerated form, comprising the steps of (a) adding powder raw ingredients into a mixer-granulator wherein the powder raw ingredients comprises: a suitable structurant according to the present invention, optionally a stabilizer powder, and fines recycled from the granulation process. Step (b), adding the active raw ingredients into the mixer-granulator in the form of a liquid solution, suspension or paste binder, and step (c) of running the mixer-granulator to provide a suitable mixing flow field for agglomeration of the fine powder raw ingredients with the binder. Optionally, step (d) the agglomerates are dried to remove moisture that may be present in excess of 10 wt %, preferably in excess of 5 wt %, and even more preferably in excess of 2 wt %. Further, optionally, step (e) removing any oversize agglomerates and recycling via a grinder, and optionally, step (f), removing any fines and recycling the fines to the mixer-granulator, as described in step (a). The preferred process is described in Example 3.

### Formulation of Granular Detergent Product

The granular detergent product may comprise one or more structured particles in addition to other detergent adjuncts. In a preferred aspect, the granular detergent product is in the form of an admixture of structured particles with other adjuncts. The composition of cleaning actives in the granular detergent product can be adjusted according to the mass fraction of structured particles comprising the cleaning actives as well as the concentration of the cleaning actives in the structured particles.

The current invention provides a means to formulate detergent agglomerates having high active concentrations, but without the residues that is commonly associated with amorphous silica materials. Fabric residue testing is typically done by a qualitative visual grading of wash residues on black fabric; the Structurant Residue Factor of the current invention correlates with a fabric cleaning product's propensity to leave fabric residues. The current invention offers two benefits to mitigate residues which must be considered together in product formulation: 1) the structurant material of the current invention, comprising adjunct salt, provides for improved dispersion of silica in wash conditions; and 2) structured particle comprising the structurant material can have a concentrated active level, thereby minimizing the amount of the particles that are required in the finished product formulation.

### Formulation of Structured Particles Comprising Cleaning Actives

The optimal formulation of a structured particle depends on several criteria, including but not limited to: 1) desired active concentration in the dose (e.g., for overall cleaning benefit); 2) admixture fraction in the product for consistent dosing; 3) concentration of the cleaning active in the available raw material; and 4) formula limitations on structurants. For granular detergent products, a reasonable guideline to have structured particles with critical cleaning actives present at a level of at least 2 wt % in the admixture. Depending on the cleaning active, raw materials comprising the active maybe available from about 30 to 100 wt % of the active's concentration; given that we may have limits on the amount of structurant that can be used in a finished product, it is generally preferable to maximize the active's concentration in the raw material.

The Saturation Capacity of a structurant with respect to a cleaning active liquid or paste can be measured using the Saturation Capacity Test as described herein. For a desired target cleaning active concentration (A), the required level of structurant (S) in the formulated structured particle can be estimated as follows. Given a cleaning active raw material concentration (R), required stabilizer/active mass ratio (B), Saturation Capacity of the structurant relative to the cleaning active raw material (SCS), and Saturation Capacity of a dry powder stabilizer relative to the cleaning active raw material (SCB):

S=A*[(1/R)−B*SCB]/SCS

If the sum, S+A+B>1, the target cleaning composition is unfeasible. To achieve a feasible target, the cleaning active raw material concentration (R) must be increased, the required stabilizer/active mass ratio (B) must be reduced, the saturation capacities (SCS, SCB) must be increased, or the target for the structured particle's cleaning active concentration (A) must be reduced.

If the sum, S+A+B<=1, the target cleaning composition is feasible, and its balance can be filled with additional materials including suitable detergent adjunct materials or even detergent filler ingredients. If the level of the additional material is significant in boosting the composite's Saturation Capacity, then the level of the structurant can be adjusted following an iterative calculation including the Saturation Capacity of the additional material.

In addition to the above feasibility constraints, the structurants′ concentration may be subject to additional constraints in order to achieve required stability and dissolution profiles; examples are provided.

### Making the Granular Detergent Product Comprising Structured Particles

A finished granular detergent product is made by mixing the structured particle with optional dry admix ingredients and/or optional liquid spray-on ingredients. Finished granular detergent product are typically formulated such that, during use in aqueous cleaning operations, the wash water will have a pH of between about 6.5 and about 12, or between about 7.5 and 10.5. Techniques for controlling pH at recommended usage levels include, but are not limited to, the use of buffers, alkalis, acids, etc., and are well known to those skilled in the art. See Example 5 for sample formulations.

Laundry detergent composition: Typically, the composition is a fully formulated laundry detergent composition, not a portion thereof such as a spray-dried or agglomerated particle that only forms part of the laundry detergent composition. However, it is within the scope of the present invention for an additional rinse additive composition (e.g., fabric conditioner or enhancer), or a main wash additive composition (e.g., bleach additive) to also be used in combination with the laundry detergent composition during the method of the present invention. Although, it may be preferred for no bleach additive composition is used in combination with the laundry detergent composition during the method of the present invention.

Typically, the composition comprises a plurality of chemically different particles, such as spray-dried base detergent particles and/or agglomerated base detergent particles and/or extruded base detergent particles, in combination with one or more, typically two or more, or three or more, or four or more, or five or more, or six or more, or even ten or more particles selected from: surfactant particles, including surfactant agglomerates, surfactant extrudates, surfactant needles, surfactant noodles, surfactant flakes; polymer particles such as cellulosic polymer particles, polyester particles, polyamine particles, terephthalate polymer particles, polyethylene glycol polymer particles; builder particles, such as sodium carbonate and sodium silicate co-builder particles, phosphate particles, zeolite particles, silicate salt particles, carbonate salt particles; filler particles such as sulphate salt particles; dye transfer inhibitor particles; dye fixative particles; bleach particles, such as percarbonate particles, especially coated percarbonate particles, such as percarbonate coated with carbonate salt, sulphate salt, silicate salt, borosilicate salt, or any combination thereof, perborate particles, bleach catalyst particles such as transition metal bleach catalyst particles, or oxaziridinium-based bleach catalyst particles, pre-formed peracid particles, especially coated pre-formed peracid particles, and co-bleach particles of bleach activator, source of hydrogen peroxide and optionally bleach catalyst; bleach activator particles such as oxybenzene sulphonate bleach activator particles and tetra acetyl ethylene diamine bleach activator particles; chelant particles such as chelant agglomerates; hueing dye particles; brightener particles; enzyme particles such as protease prills, lipase prills, cellulase prills, amylase prills, mannanase prills, pectate lyase prills, xyloglucanase prills, bleaching enzyme prills, cutinase prills and co-prills of any of these enzymes; clay particles such as montmorillonite particles or particles of clay and silicone; flocculant particles such as polyethylene oxide particles; wax particles such as wax agglomerates; perfume particles such as perfume microcapsules, especially melamine formaldehyde-based perfume microcapsules, starch encapsulated perfume accord particles, and pro-perfume particles such as Schiff base reaction product particles; aesthetic particles such as coloured noodles or needles or lamellae particles, and soap rings including coloured soap rings; and any combination thereof.

Detergent ingredients: The composition typically comprises detergent ingredients. Suitable detergent ingredients include: detersive surfactants including anionic detersive surfactants, non-ionic detersive surfactants, cationic detersive surfactants, zwitterionic detersive surfactants, amphoteric detersive surfactants, and any combination thereof; polymers including carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in a ratio of 1:4:1, hexamethylenediamine derivative polymers, and any combination thereof; builders including zeolites, phosphates, citrate, and any combination thereof; buffers and alkalinity sources including carbonate salts and/or silicate salts; fillers including sulphate salts and bio-filler materials; bleach including bleach activators, sources of available oxygen, pre-formed peracids, bleach catalysts, reducing bleach, and any combination thereof; chelants; photobleach; hueing agents; brighteners; enzymes including proteases, amylases, cellulases, lipases, xylogucanases, pectate lyases, mannanases, bleaching enzymes, cutinases, and any combination thereof; fabric softeners including clay, silicones, quaternary ammonium fabric-softening agents, and any combination thereof; flocculants such as polyethylene oxide; perfume including starch encapsulated perfume accords, perfume microcapsules, perfume loaded zeolites, schif base reaction products of ketone perfume raw materials and polyamines, blooming perfumes, and any combination thereof; aesthetics including soap rings, lamellar aesthetic particles, geltin beads, carbonate and/or sulphate salt speckles, coloured clay, and any combination thereof: and any combination thereof.

Detersive surfactant: The composition typically comprises detersive surfactant. Suitable detersive surfactants include anionic detersive surfactants, non-ionic detersive surfactant, cationic detersive surfactants, zwitterionic detersive surfactants, amphoteric detersive surfactants, and any combination thereof.

Anionic detersive surfactant: Suitable anionic detersive surfactants include sulphate and sulphonate detersive surfactants.

Preferably, the quantity of anionic detersive surfactant is in the range of from 5 to 50% by weight of the total composition. More preferably, the quantity of anionic surfactant is in the range of from about 8% to about 35% by weight.

Suitable sulphonate detersive surfactants include alkyl benzene sulphonate, such as C₁₀₋₁₃ alkyl benzene sulphonate. Suitable alkyl benzene sulphonate (LAS) is obtainable, or even obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. Another suitable anionic detersive surfactant is alkyl benzene sulphonate that is obtained by DETAL catalyzed process, although other synthesis routes, such as HF, may also be suitable.

Suitable sulphate detersive surfactants include alkyl sulphate, such as C₈₋₁₈ alkyl sulphate, or predominantly C₁₂ alkyl sulphate. The alkyl sulphate may be derived from natural sources, such as coco and/or tallow. Alternative, the alkyl sulphate may be derived from synthetic sources such as C₁₂₋₁₅ alkyl sulphate.

Another suitable sulphate detersive surfactant is alkyl alkoxylated sulphate, such as alkyl ethoxylated sulphate, or a C₈₋₁₈ alkyl alkoxylated sulphate, or a C₈₋₁₈ alkyl ethoxylated sulphate. The alkyl alkoxylated sulphate may have an average degree of alkoxylation of from 0.5 to 20, or from 0.5 to 10. The alkyl alkoxylated sulphate may be a C₈₋₁₈ alkyl ethoxylated sulphate, typically having an average degree of ethoxylation of from 0.5 to 10, or from 0.5 to 7, or from 0.5 to 5 or from 0.5 to 3.

The alkyl sulphate, alkyl alkoxylated sulphate and alkyl benzene sulphonates may be linear or branched, substituted or un-substituted.

The anionic detersive surfactant may be a mid-chain branched anionic detersive surfactant, such as a mid-chain branched alkyl sulphate and/or a mid-chain branched alkyl benzene sulphonate. The mid-chain branches are typically C₁₋₄ alkyl groups, such as methyl and/or ethyl groups.

Another suitable anionic detersive surfactant is alkyl ethoxy carboxylate.

The anionic detersive surfactants are typically present in their salt form, typically being complexed with a suitable cation. Suitable counter-ions include Na⁺ and K⁺, substituted ammonium such as C₁-C₆ alkanolammnonium such as mono-ethanolamine (MEA) tri-ethanolamine (TEA), di-ethanolamine (DEA), and any mixture thereof.

Non-ionic detersive surfactant: Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein optionally the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, typically having an average degree of alkoxylation of from 1 to 30; alkylpolysaccharides, such as alkylpolyglycosides; polyhydroxy fatty acid amides; ether capped poly(oxyalkylated) alcohol surfactants; and mixtures thereof.

Suitable non-ionic detersive surfactants are alkyl polyglucoside and/or an alkyl alkoxylated alcohol.

Non-ionic detersive surfactant, if present, is preferably used in an amount within the range of from about 1% to about 20% by weight.

Suitable non-ionic detersive surfactants include alkyl alkoxylated alcohols, such as C₈₋₁₈ alkyl alkoxylated alcohol, or a C₈₋₁₈ alkyl ethoxylated alcohol. The alkyl alkoxylated alcohol may have an average degree of alkoxylation of from 0.5 to 50, or from 1 to 30, or from 1 to 20, or from 1 to 10. The alkyl alkoxylated alcohol may be a C₈₋₁₈ alkyl ethoxylated alcohol, typically having an average degree of ethoxylation of from 1 to 10, or from 1 to 7, or from 1 to 5, or from 3 to 7. The alkyl alkoxylated alcohol can be linear or branched, and substituted or un-substituted.

Suitable nonionic detersive surfactants include secondary alcohol-based detersive surfactants having the formula (I):

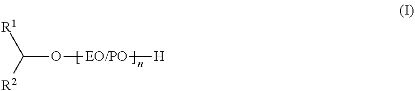

wherein R¹=linear or branched, substituted or unsubstituted, saturated or unsaturated C₂₋₈ alkyl;
wherein R²=linear or branched, substituted or unsubstituted, saturated or unsaturated C₂₋₈ alkyl,
wherein the total number of carbon atoms present in R¹+R² moieties is in the range of from 7 to 13;
wherein EO/PO are alkoxy moieties selected from ethoxy, propoxy, or mixtures thereof, optionally the EO/PO alkoxyl moieties are in random or block configuration;
wherein n is the average degree of alkoxylation and is in the range of from 4 to 10.

Other suitable non-ioSundaynic detersive surfactants include EO/PO block co-polymer surfactants, such as the Plurafac® series of surfactants available from BASF, and sugar-derived surfactants such as alkyl N-methyl glucose amide.

Suitable nonionic detersive surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic detersive surfactant: Suitable cationic detersive surfactants include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula (II):

(R)(R₁)(R₂)(R₃)N⁺X⁻ (II)

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, such as chloride; sulphate; and sulphonate. Suitable cationic detersive surfactants are mono-C₆₋₁₈ alkyl mono-hydroxyethyl di-methyl quaternary ammonium chlorides. Suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Zwitterionic and/or amphoteric detersive surfactant: Suitable zwitterionic and/or amphoteric detersive surfactants include amine oxide such as dodecyldimethylamine N-oxide, alkanolamine sulphobetaines, coco-amidopropyl betaines, HN⁺—R—CO₂⁻ based surfactants, wherein R can be any bridging group, such as alkyl, alkoxy, aryl or amino acids. Many suitable detergent active compounds are available and are fully described in the literature, for example, in “Surface-Active Agents and Detergents”, Volumes I and II, by Schwartz, Perry and Berch, hereby incorporated by reference.

Chelants: Suitable chelants can also include: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The cleaning composition may comprise ethylene diamine-N′N′-disuccinic acid or salt thereof. The ethylene diamine-N′N′-disuccinic acid may be in S,S enantiomeric form. The cleaning composition may comprise 4,5-dihydroxy-m-benzenedisulfonic acid disodium salt. Suitable chelants may also be calcium crystal growth inhibitors.

Polymers: Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Carboxylate polymer: Suitable carboxylate polymers include maleate/acrylate random copolymer or polyacrylate homopolymer. The carboxylate polymer may be a polyacrylate homopolymer having a molecular weight of from 4,000 Da to 9,000 Da, or from 6,000 Da to 9,000 Da. Other suitable carboxylate polymers are co-polymers of maleic acid and acrylic acid, and may have a molecular weight in the range of from 4,000 Da to 90,000 Da.

Polymers: Preferably, the polymers are polyethylene glycol polymer. Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan® HP22.

Polyester soil release polymers: Suitable polyester soil release polymers have a structure as defined by one of the following structures (III), (IV) or (V):

—[(OCHR¹—CHR²)ₐ—O—OC—Ar—CO—]_{d} (III)

—[(OCHR³—CHR⁴)_{b}—O—OC-sAr—CO—]ₑ (IV)

—[(OCHR⁵—CHR⁶)_{c}—OR⁷]_{f} (V)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is H, Na, Li, K, Mg/2, Ca/2, Al/3, ammonium, mono-, di-, tri-, or tetra-alkylammonium wherein the alkyl groups are C₁-C₁₈ alkyl or C₂-C₁₀ hydroxyalkyl, or any mixture thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable polyester soil release polymers are terephthalate polymers having the structure (III) or (IV) above.

Suitable polyester soil release polymers include the Repel-o-tex® series of polymers such as Repel-o-tex® SF2 (Rhodia) and/or the Texcare series of polymers such as Texcare® SRA300 (Clariant).

Other suitable soil release polymers may include, for example sulphonated and unsulphonated PET/POET polymers, both end-capped and non-end-capped, and olyethylene glycol/polyvinyl alcohol graft copolymers such as Sokolan® HP222.

Especially preferred soil release polymers are the sulphonated non-end-capped polyesters described and claimed in WO 95/32997A (Rhodia Chimie), hereby incorporated by reference.

Amine polymer: Suitable amine polymers include polyethylene imine polymers, such as alkoxylated polyalkyleneimines, optionally comprising a polyethylene and/or polypropylene oxide block.

Cellulosic polymer: The cleaning composition can comprise cellulosic polymers, such as polymers selected from alkyl cellulose, alkyl alkoxyalkyl cellulose, carboxyalkyl cellulose, alkyl carboxyalkyl, and any combination thereof. Suitable cellulosic polymers are selected from carboxymethyl cellulose, methyl cellulose, methyl hydroxyethyl cellulose, methyl carboxymethyl cellulose, and mixtures thereof. The carboxymethyl cellulose can have a degree of carboxymethyl substitution from 0.5 to 0.9 and a molecular weight from 100,000 Da to 300,000 Da. Another suitable cellulosic polymer is hydrophobically modified carboxymethyl cellulose, such as Finnfix SH-1 (CP Kelco).

Other suitable cellulosic polymers may have a degree of substitution (DS) of from 0.01 to 0.99 and a degree of blockiness (DB) such that either DS+DB is of at least 1.00 or DB+2DS−DS2 is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose. Random graft co-polymer. Suitable random graft co-polymers typically comprise: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (VI) and (VII).
(VI)

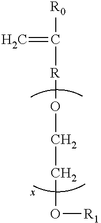

wherein in formula (VI), Rₒ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group.

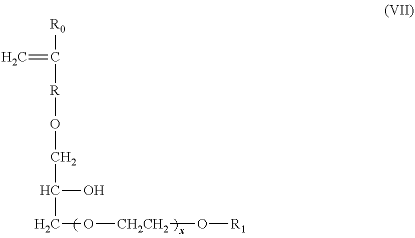

in formula (VII), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

Dye transfer inhibitor polymer: Suitable dye transfer inhibitor (DTI) polymers include polyvinyl pyrrolidone (PVP), vinyl co-polymers of pyrrolidone and imidazoline (PVPVI), polyvinyl N-oxide (PVNO), and any mixture thereof.

Hexamethylenediamine derivative polymers: Suitable polymers includehexamethylenediamine derivative polymers, typically having the formula (VIII):

R₂(CH₃)N⁺(CH₂)6N⁺(CH₃)R₂.2X⁻ (VIII)

wherein X⁻ is a suitable counter-ion, for example chloride, and R is a poly(ethylene glycol) chain having an average degree of ethoxylation of from 20 to 30. Optionally, the poly(ethylene glycol) chains may be independently capped with sulphate and/or sulphonate groups, typically with the charge being balanced by reducing the number of X⁻ counter-ions, or (in cases where the average degree of sulphation per molecule is greater than two), introduction of Y⁺ counter-ions, for example sodium cations.

In another aspect, the cleaning active comprises citrate. A suitable citrate is sodium citrate. However, citric acid may also be incorporated into the cleaning composition, which can form citrate in the wash liquor.

In another aspect, the cleaning active comprises bleach. The cleaning composition may comprise bleach. Alternatively, the cleaning composition may be substantially free of bleach; substantially free means “none deliberately added”. Suitable bleach includes bleach activators, sources of available oxygen, pre-formed peracids, bleach catalysts, reducing bleach, and any combination thereof. If present, the bleach, or any component thereof, for example the pre-formed peracid, may be coated, such as encapsulated, or clathrated, such as with urea or cyclodextrin.

In another aspect, the cleaning active comprises bleach activator. Suitable bleach activators include: tetraacetylethylenediamine (TAED); oxybenzene sulphonates such as nonanoyl oxybenzene sulphonate (NOBS), caprylamidononanoyl oxybenzene sulphonate (NACA-OBS), 3,5,5-trimethyl hexanoyloxybenzene sulphonate (Iso-NOBS), dodecyl oxybenzene sulphonate (LOBS), and any mixture thereof; caprolactams; pentaacetate glucose (PAG); nitrile quaternary ammonium; imide bleach activators, such as N-nonanoyl-N-methyl acetamide; and any mixture thereof.

In another aspect, the cleaning active comprises source of available oxygen. A suitable source of available oxygen (AvOx) is a source of hydrogen peroxide, such as percarbonate salts and/or perborate salts, such as sodium percarbonate. The source of peroxygen may be at least partially coated, or even completely coated, by a coating ingredient such as a carbonate salt, a sulphate salt, a silicate salt, borosilicate, or any mixture thereof, including mixed salts thereof. Suitable percarbonate salts can be prepared by a fluid bed process or by a crystallization process. Suitable perborate salts include sodium perborate mono-hydrate (PB1), sodium perborate tetra-hydrate (PB4), and anhydrous sodium perborate which is also known as fizzing sodium perborate. Other suitable sources of AvOx include persulphate, such as oxone. Another suitable source of AvOx is hydrogen peroxide.

In another aspect, the cleaning active comprises pre-formed peracid. A suitable pre-formed peracid is N,N-pthaloylamino peroxycaproic acid (PAP).

In another aspect, the cleaning active comprises bleach catalyst. Suitable bleach catalysts include oxaziridinium-based bleach catalysts, transition metal bleach catalysts and bleaching enzymes.

In another aspect, the cleaning active comprises oxaziridinium-based bleach catalyst. A suitable oxaziridinium-based bleach catalyst has the formula (IX):

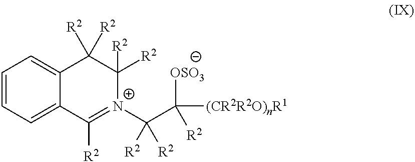

wherein: R¹ is selected from the group consisting of: H, a branched alkyl group containing from 3 to 24 carbons, and a linear alkyl group containing from 1 to 24 carbons; R¹ can be a branched alkyl group comprising from 6 to 18 carbons, or a linear alkyl group comprising from 5 to 18 carbons, R¹ can be selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons; optionally R² is independently selected from the group consisting of H, methyl, a branched alkyl group comprising from 3 to 12 carbons, and a linear alkyl group comprising from 1 to 12 carbons; and n is an integer from 0 to 1. Oxaziridinium-based bleach booster can be produced according to US Patent Publication No. 2006/0089284A1.

In another aspect, the cleaning active comprises transition metal bleach catalyst. The cleaning composition may include transition metal bleach catalyst, typically comprising copper, iron, titanium, ruthenium, tungsten, molybdenum, and/or manganese cations. Suitable transition metal bleach catalysts are manganese-based transition metal bleach catalysts.

In another aspect, the cleaning active comprises reducing bleach. The cleaning composition may comprise a reducing bleach. However, the cleaning composition may be substantially free of reducing bleach; substantially free means “none deliberately added”. Suitable reducing bleach include sodium sulphite and/or thiourea dioxide (TDO).

In another aspect, the cleaning active comprises a co-bleach particle. The cleaning composition may comprise a co-bleach particle. Typically, the co-bleach particle comprises a bleach activator and a source of peroxide. It may be highly suitable for a large amount of bleach activator relative to the source of hydrogen peroxide to be present in the co-bleach particle. The weight ratio of bleach activator to source of hydrogen peroxide present in the co-bleach particle can be at least 0.3:1, or at least 0.6:1, or at least 0.7:1, or at least 0.8:1, or at least 0.9:1, or at least 1.0:1.0, or even at least 1.2:1 or higher.

The co-bleach particle can comprise: (i) bleach activator, such as TAED; and (ii) a source of hydrogen peroxide, such as sodium percarbonate. The bleach activator may at least partially, or even completely, enclose the source of hydrogen peroxide.

The co-bleach particle may comprise a binder. Suitable binders are carboxylate polymers such as polyacrylate polymers, and/or surfactants including non-ionic detersive surfactants and/or anionic detersive surfactants such as linear C₁₁-C₁₃ alkyl benzene sulphonate.

In another aspect, the cleaning active comprises a bleach stabilizer (heavy metal sequestrant). Suitable bleach stabilizers include ethylenediamine tetraacetate (EDTA) and the polyphosphonates such as Dequest®, EDTMP.

In another aspect, the cleaning active comprises photobleach. Suitable photobleaches are zinc and/or aluminium sulphonated phthalocyanines.

In another aspect, the cleaning active comprises brightener. It may be preferred for the cleaning composition to comprise fluorescent brighteners such as disodium 4,4′-bis(2-sulfostyryl)biphenyl (C.I. Fluorescent Brightener 351); C.I. Fluorescent Brightener 260, or analogues with its anilino- or morpholino-groups replaced by other groups. Suitable C.I. Fluorescent Brightener 260 may have the following structure (X):

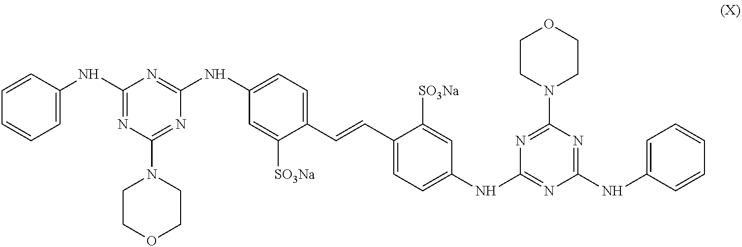

wherein the C.I. fluorescent brightener 260 is either:

predominantly in alpha-crystalline form; or

predominantly in beta-crystalline form and having a weight average primary particle size of from 3 to 30 micrometers.

In another aspect, the cleaning active comprises bleach-stable fluorescent brighteners such as bis(sulfobenzofuranyl)biphenyl, commercially available from Ciba Specialty Chemicals as Tinopal® PLC.

In another aspect, the cleaning active comprises hueing agent. The cleaning composition may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in EP1794275 or EP1794276, or dyes as disclosed in U.S. Pat. No. 7,208,459 B2, and mixtures thereof. In another aspect, suitable small molecule dyes include small molecule dyes selected from the group consisting of C. I. numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in W02011/98355, W02011/47987, US2012/090102, WO2010/145887, WO2006/055787 and WO2010/142503.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Preferred hueing dyes include the whitening agents found in PCT Publication Nos. WO 08/87497 A1, WO2011/011799 and WO2012/054835. Preferred hueing agents for use in the present invention may be the preferred dyes disclosed in these references, including those selected from Examples 1-42 in Table 5 of WO2011/011799. Other preferred dyes are disclosed in U.S. Pat. No. 8,138,222. Other preferred dyes are disclosed in PCT Publication No. WO2009/069077.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The aforementioned fabric hueing agents can be used in combination (any mixture of fabric hueing agents can be used).

In another aspect, the cleaning active comprises enzyme. Suitable enzymes include proteases, amylases, cellulases, lipases, xylogucanases, pectate lyases, mannanases, bleaching enzymes, cutinases, and mixtures thereof. For the enzymes, accession numbers and IDs shown in parentheses refer to the entry numbers in the databases Genbank, EMBL and/or Swiss-Prot. For any mutations, standard 1-letter amino acid codes are used with a * representing a deletion. Accession numbers prefixed with DSM refer to micro-organisms deposited at Deutsche Sammlung von Mikroorganismen and Zellkulturen GmbH, Mascheroder Weg 1b, 38124 Brunswick (DSMZ).

Protease. The composition may comprise a protease. Suitable proteases include metalloproteases and/or serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), including those derived from Bacillus, such as Bacillus lentus, Bacillus alkalophilus (P27963, ELYA_BACAO), Bacillus subtilis, Bacillus amyloliquefaciens (P00782, SUBT_BACAM), Bacillus pumilus (P07518) and Bacillus gibsonii (DSM14391).
(b) trypsin-type or chymotrypsin-type proteases, such as trypsin (e.g. of porcine or bovine origin), including the Fusarium protease and the chymotrypsin proteases derived from Cellumonas (A2RQE2).
(c) metalloproteases, including those derived from Bacillus amyloliquefaciens (P06832, NPRE_BACAM).

Suitable proteases include those derived from Bacillus gibsonii or Bacillus Lentus such as subtilisin 309 (P29600) and/or DSM 5483 (P29599).

Suitable commercially available protease enzymes include: those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Genencor International; those sold under the tradename Opticlean® and Optimase® by Solvay Enzymes; those available from Henkel/Kemira, namely BLAP (P29599 having the following mutations S99D+S101 R+S103A+V104I+G159S), and variants thereof including BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D) all from Henkel/Kemira; and KAP (Bacillus alkalophilus subtilisin with mutations A230V+S256G+S259N) from Kao.

In another aspect, suitable proteolytic enzymes (proteases) may be catalytically active protein materials which degrade or alter protein types of stains when present as in fabric stains in a hydrolysis reaction. They may be of any suitable origin, such as vegetable, animal, bacterial or yeast origin. Proteolytic enzymes or proteases of various qualities and origins and having activity in various pH ranges of from 4-12 are available. Proteases of both high and low isoelectric point are suitable.

Amylase: Suitable amylases are alpha-amylases, including those of bacterial or fungal origin. Chemically or genetically modified mutants (variants) are included. A suitable alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, sp 707, DSM 9375, DSM 12368, DSM no. 12649, KSM AP1378, KSM K36 or KSM K38. Suitable amylases include:
(a) alpha-amylase derived from Bacillus licheniformis (P06278, AMY_BACLI), and variants thereof, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444;
(b) AA560 amylase (CBU30457, HD066534) and variants thereof, especially the variants with one or more substitutions in the following positions: 26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, optionally that also contain the deletions of D183* and G184*;
(c) DSM 12649 having: (a) mutations at one or more of positions 9, 26, 149, 182, 186, 202, 257, 295, 299, 323, 339 and 345; and (b) optionally with one or more, preferably all of the substitutions and/or deletions in the following positions: 118, 183, 184, 195, 320 and 458, which if present preferably comprise R118K, DI83*, GI84*, N195F, R320K and/or R458K; and
(d) variants exhibiting at least 90% identity with the wild-type enzyme from Bacillus SP722 (CBU30453, HD066526), especially variants with deletions in the 183 and 184 positions.

Suitable commercially available alpha-amylases are Duramyl®, Liquezyme® Termamyl®, Termamyl Ultra®, Natalase®, Supramyl®, Stainzyme®, Stainzyme Plus®, Fungamyl® and BAN® (Novozymes A/S), Bioamylase® and variants thereof (Biocon India Ltd.), Kemzym® AT 9000 (Biozym Ges. m.b.H, Austria), Rapidase®, Purastar®, Optisize HT Plus®, Enzysize®, Powerase® and Purastar Oxam®, Maxamyl® (Genencor International Inc.) and KAM® (KAO, Japan). Suitable amylases are Natalase®, Stainzyme® and Stainzyme Plus®.

Cellulase: The cleaning composition may comprise a cellulase. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, and Carezyme® (Novozymes A/S), Clazinase®, and Puradax HA® (Genencor International Inc.), and KAC-500(B)® (Kao Corporation).

The cellulase can include microbial-derived endoglucanases exhibiting endo-beta-1,4-glucanase activity (E.C. 3.2.1.4), including a bacterial polypeptide endogenous to a member of the genus Bacillus sp. AA349 and mixtures thereof. Suitable endoglucanases are sold under the tradenames Celluclean® and Whitezyme® (Novozymes A/S, Bagsvaerd, Denmark).

Suitable cellulases may also exhibit xyloglucanase activity, such as Whitezyme®.

Lipase: The composition may comprise a lipase. Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus), or from H. insolens, a Pseudomonas lipase, e.g., from P. alcaligenes or P. pseudoalcaligenes, P. cepacia, P. stutzeri, P. fluorescens, Pseudomonas sp. strain SD 705, P. wisconsinensis, a Bacillus lipase, e.g., from B. subtilis, B. stearothermophilus or B. pumilus.

The lipase may be a “first cycle lipase”, optionally a variant of the wild-type lipase from Thermomyces lanuginosus comprising T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Suitable lipases would include those sold under the tradenames Lipex®, Lipolex® and Lipoclean® by Novozymes, Bagsvaerd, Denmark.

The cleaning composition may comprise a variant of Thermomyces lanuginosa (O59952) lipase having >90% identity with the wild type amino acid and comprising substitution(s) at T231 and/or N233, optionally T231R and/or N233R.

Xyloglucanase: Suitable xyloglucanase enzymes may have enzymatic activity towards both xyloglucan and amorphous cellulose substrates. The enzyme may be a Glycosyl Hydrolase (GH) selected from GH families 5, 12, 44, 45 or 74. The glycosyl hydrolase selected from GH family 44 is particularly suitable. Suitable glycosyl hydrolases from GH family 44 are the XYG1006 glycosyl hydrolase from Paenibacillus polyxyma (ATCC 832) and variants thereof.

Also particularly suitable is the glycosyl hydrolase selected from GH family 45 having a molecular weight of from 17 kDa to 30 kDa, for example the endoglucanases sold under the tradename Biotouch® NCD, DCC and DCL (AB Enzymes, Darmstadt, Germany).

Pectate lyase: Suitable pectate lyases are either wild-types or variants of Bacillus-derived pectate lyases (CAF05441, AAU25568) sold under the tradenames Pectawash®, Pectaway® and X-Pect® (from Novozymes A/S, Bagsvaerd, Denmark).

Mannanase: Suitable mannanases are sold under the tradenames Mannaway® (from Novozymes A/S, Bagsvaerd, Denmark), and Purabrite® (Genencor International Inc., Palo Alto, Calif.).

Bleaching enzyme: Suitable bleach enzymes include oxidoreductases, for example oxidases such as glucose, choline or carbohydrate oxidases, oxygenases, catalases, peroxidases, like halo-, chloro-, bromo-, lignin-, glucose- or manganese-peroxidases, dioxygenases or laccases (phenoloxidases, polyphenoloxidases). Suitable commercial products are sold under the Guardzyme® and Denilite® ranges from Novozymes. It may be advantageous for additional organic compounds, especially aromatic compounds, to be incorporated with the bleaching enzyme; these compounds interact with the bleaching enzyme to enhance the activity of the oxidoreductase (enhancer) or to facilitate the electron flow (mediator) between the oxidizing enzyme and the stain typically over strongly different redox potentials.

Other suitable bleaching enzymes include perhydrolases, which catalyse the formation of peracids from an ester substrate and peroxygen source. Suitable perhydrolases include variants of the Mycobacterium smegmatis perhydrolase, variants of so-called CE-7 perhydrolases, and variants of wild-type subtilisin Carlsberg possessing perhydrolase activity.

Cutinase: Suitable cutinases are defined by E.C. Class 3.1.1.73, optionally displaying at least 90%, or 95%, or most optionally at least 98% identity with a wild-type derived from one of Fusarium solani, Pseudomonas Mendocina or Humicola Insolens.

Identity. The relativity between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

In another aspect, the cleaning active comprises fabric-softener. Suitable fabric-softening agents include clay, silicone and/or quaternary ammonium compounds. Suitable clays include montmorillonite clay, hectorite clay and/or laponite clay. A suitable clay is montmorillonite clay.

Suitable silicones include amino-silicones and/or polydimethylsiloxane (PDMS). A suitable fabric softener is a particle comprising clay and silicone, such as a particle comprising montmorillonite clay and PDMS.

In another aspect, the cleaning active comprises flocculant. Suitable flocculants include polyethylene oxide; for example having an average molecular weight of from 300,000 Da to 900,000 Da.

In another aspect, the cleaning active comprises suds suppressor. Suitable suds suppressors include silicone and/or fatty acid such as stearic acid.

In another aspect, the cleaning active comprises perfume. Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

In another aspect, the cleaning active comprises other aesthetic. Other suitable aesthetic particles may include soap rings, lamellar aesthetic particles, geltin beads, carbonate and/or sulphate salt speckles, coloured clay particles, and any combination thereof.

Builder: Suitable builders include zeolites, phosphates, citrates, and any combination thereof.

Zeolite builder: The composition may be substantially free of zeolite builder. Substantially free of zeolite builder typically means comprises from 0 wt % to 10 wt %, zeolite builder, or to 8 wt %, or to 6 wt %, or to 4 wt %, or to 3 wt %, or to 2 wt %, or even to 1 wt % zeolite builder. Substantially free of zeolite builder preferably means “none deliberately added” zeolite builder. Typical zeolite builders include zeolite A, zeolite P, zeolite MAP, zeolite X and zeolite Y.

Phosphate builder: The composition may be substantially free of phosphate builder. Substantially free of phosphate builder typically means comprises from 0 wt % to 10 wt % phosphate builder, or to 8 wt %, or to 6 wt %, or to 4 wt %, or to 3 wt %, or to 2 wt %, or even to 1 wt % phosphate builder. Substantially free of phosphate builder preferably preferably means “none deliberately added” phosphate builder. A typical phosphate builder is sodium tripolyphosphate (STPP), which may be used in combination with sodium orthophosphate, and/or sodium pyrophosphate.

Other inorganic builders that may be present additionally or alternatively include sodium carbonate, and/or sodium bicarbonate.

Organic builders that may be present include polycarboxylate polymers such as polyacrylates and acrylic/maleic copolymers; polyaspartates; monomeric polycarboxylates such as citrates, gluconates, oxydisuccinates, glycerol mono-di- and trisuccinates, carboxymethyloxysuccinates, carboxy-methyloxymalonates, dipicolinates, hydroxyethyliminodiacetates, alkyl- and alkenylmalonates and succinates; and sulphonated fatty acid salts.

Buffer and alkalinity source: Suitable buffers and alkalinity sources include carbonate salts and/or silicate salts and/or double salts such as burkeitte.

Carbonate salt: A suitable carbonate salt is sodium carbonate and/or sodium bicarbonate. The composition may comprise bicarbonate salt. It may be suitable for the composition to comprise low levels of carbonate salt, for example, it may be suitable for the composition to comprise from 0 wt % to 10 wt % carbonate salt, or to 8 wt %, or to 6 wt %, or to 4 wt %, or to 3 wt %, or to 2 wt %, or even to 1 wt % carbonate salt. The composition may even be substantially free of carbonate salt; substantially free means “none deliberately added”.

The carbonate salt may have a weight average mean particle size of from 100 to 500 micrometers. Alternatively, the carbonate salt may have a weight average mean particle size of from 10 to 25 micrometers.

Silicate salt: The composition may comprise from 0 wt % to 20 wt % silicate salt, or to 15 wt %, or to 10 wt %, or to 5 wt %, or to 4 wt %, or even to 2 wt %, and may comprise from above 0 wt %, or from 0.5 wt %, or even from 1 wt % silicate salt. The silicate can be crystalline or amorphous. Suitable crystalline silicates include crystalline layered silicate, such as SKS-6. Other suitable silicates include 1.6R silicate and/or 2.0R silicate. A suitable silicate salt is sodium silicate. Another suitable silicate salt is sodium metasilicate.

In an embodiment, the structurant can comprises at least 15 wt % of an alkali metal salt selected from the group comprising of Na₂CO₃, Na₂SO₄, Na₂SiO₃, Sodium Tripolyphosphate, and magnesium sulphate.

Filler: The composition may comprise from 0 wt % to 70 wt % filler. Suitable fillers include sulphate salts and/or bio-filler materials.

Sulphate salt: A suitable sulphate salt is sodium sulphate. The sulphate salt may have a weight average mean particle size of from 100 to 500 micrometers, alternatively, the sulphate salt may have a weight average mean particle size of from 10 to 45 micrometers.

Bio-filler material: A suitable bio-filler material is alkali and/or bleach treated agricultural waste.

Calcium carbonate crystal growth inhibitor: The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

Antiredeposition agents, for example, cellulose esters and ethers, for example sodium carboxymethyl cellulose, may also be present.

Other ingredients that may be present include solvents, hydrotropes, such as sodium, or calcium cumene sulfonate, potassium napthalenesulfonate, or the like, fluorescers, foam boosters or foam controllers (antifoams) as appropriate, sodium carbonate, sodium bicarbonate, sodium silicate, sodium sulphate, sodium acetate, TEA-25 (polyethylene glycol ether of catylalcohol), calcium chloride, other inorganic salts, flow aids such as silicas and amorphous aluminosilicates, fabric conditioning compounds, clay and soil removal/anti-redeposition agents, other perfumes or pro-perfumes, and combinations of one or more of these cleaning adjuncts.

### Methods of Using the Cleaning Compositions

The compositions are typically used for cleaning and/or treating a situs inter alia a surface or fabric. Such method includes the steps of contacting an embodiment of the cleaning composition, in neat form or diluted in a wash liquor, with at least a portion of a surface or fabric, then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method may comprise the steps of contacting a fabric to be laundered with a laundry detergent comprising at least one embodiment of the cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C., preferably cold-water temperature ranges are used. The water to fabric ratio is typically from about 1:1 to about 30:1.

The method of laundering fabric may be carried out in a top-loading or front-loading automatic washing machine, or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water.

Typically from 0.01 Kg to 2 Kg of fabric per litre of wash liquor is dosed into the wash liquor. Typically from 0.01 Kg, or from 0.05 Kg, or from 0.07 Kg, or from 0.10 Kg, or from 0.15 Kg, or from 0.20 Kg, or from 0.25 Kg fabric per litre of wash liquor is dosed into the wash liquor.

Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor.

### Test Methods

Various equivalent techniques are known in the art to determine the properties of the cleaning compositions comprising the structured particles of the invention, however, in order that the invention described and claimed herein may be more fully understood, the following assays are set forth.

### Test 1: Saturation Capacity Test

The Saturation Capacity of a certain material, such as for non-limiting example, a powder, can be highly dependent on the substrate and the liquid that needs to be absorbed. There are several ways to measure the Saturation Capacity of the powder. A well known method in the industry, DIN 53601, is through the use of a torque rheometer and DBP (Dibutyl Phtalate). Alternatively, the oil-absorption method, DIN ISO 787/5 can also be used. These methods record the evolution of the measured torque as the liquid is added at a controlled rate. A typical torque profile will have a slight increase initially over time followed by a sharp peak then a drop. The peak is typically defined as the saturation point of the powder. It calculates the amount of DBP added to the powder to reach the peak torque. However, this method uses a paddle that resembles a Z blade mixer. This design does not incorporate the chopping effect that occurs in most agglomeration processing, whereby oversized materials are typically reduced. This is critical because the chopping action and breakage of oversized materials help in the surface renewal that improves the Saturation Capacity. In addition to this, the method uses a liquid that is significantly different in rheology than one would typically use in agglomeration. Finally, the structurant of the current invention has a composite structure having silica and salt phases; the latter being water soluble, therefore more interactive with aqueous actives of the current invention. For these reasons, the values typically obtained in such method give some indication of the material's internal structure or porosity, but may not necessarily correlate with the agglomeration relevant Saturation Capacity. It is therefore important that the method is relevant to the particular application of the present invention.

The method that is presented here modifies the well-accepted method, and requires measuring the resulting oversize material greater than about 1.4 mm at different AE3S paste addition levels. A 70% active aqueous paste of sodium alkylethoxysulfate, with an average molar ethoxylation of 3 (AE3S), is used as a standard liquid in the saturation capacity test. The 70% AE3S paste, also known as Sodium Lauryl Ether Sulfate (SLES 3EO) is available as a commercial feedstock material from a number of suppliers. The level of AE3S paste in relation to the powder is expressed as AE3S paste:powder weight ratio. The paste is dispersed using the Kenwood food processor (Mini Chopper/Mill CH180A). The Kenwood food processor is a portable high shear mixer consisting of: (1) a motor, (2) a small cylindrical cup with a slightly slanted wall characterized by a top diameter of about 10.6 cm, a bottom diameter of about 9.9 cm and a vertical height of about 5.35 cm, (3) a pair of blades that are attached to the near bottom opposite sides of a vertical shaft driven by the motor, with a blade length of about 4.8 cm each, and (4) a lid. The gap between each blade and the wall of the cylindrical cup is about 0.15 cm. The shaft speed of this food processor is about 3800 RPM, which translates into a tip speed of about 2 m/s. Any other commercially available vertical axis food processor or mixer having a shaft with 2 impeller blades substantially sweeping the bottom of the mixer bowl at a tip speed of from about 1.5 m/s to 3 m/s can also be used for dispersing the paste in the present invention.

The % oversize is plotted on the Y axis and the AES paste:powder ratio on the X-axis. At least 5 data points are generated, preferably where the 2 first data point are below saturation, the third at or near its saturation, and the last 2 data points above its saturation. A least square fit using the 5 data points with Pearson coefficient of at least 0.9, preferably >0.95. The typical resulting curve is best described as an exponential curve. The saturation point is estimated at the intersection of this curve fit and the 10% oversize. The AE3S paste/powder weight ratio at this point is defined to be its Saturation Capacity. Beyond this point, any additional liquid loading will result to a significant increase in oversize. This would normally result in actual industrial practice to equipment make up (e.g., wet oversize sieve blinding) or process instability, especially in continuous agglomeration process.

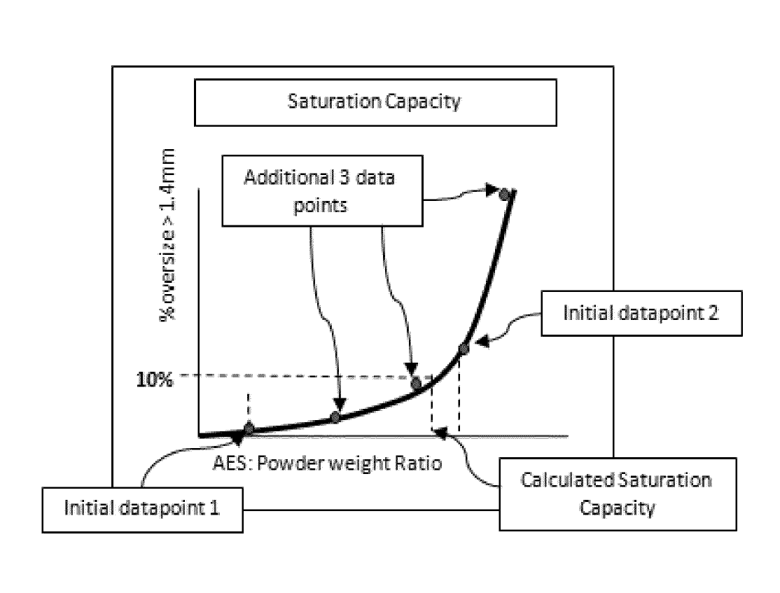

The method described below shows the steps for conducting the Saturation Capacity Test:
1. Weigh approximately 20 g of the powder to be tested (where powder bulk density is approximately in the range of 100 to 300 gpl) in the small Kenwood food mixer. The powder weight could be adjusted depending on its bulk density to have similar fill level. AES paste is weighed out in a syringe. A hole can be drilled on top of the mixer in a location where the blades can chop the paste as it is being added.
2. Turn on the mixer and allow the powder to be mixed for 2 seconds prior to adding the AES paste. The paste is then added using the syringe at approximately 120 g/min. The mixer is continued for approximately 1 second after all the pasted has been added. The resulting agglomerate is then sieved through a 1.4 mm metal sieve for 1 minute. Oversized materials retained on the screen and the undersize materials that passed through the screen are weighed separately. Amount of oversized is calculated by % oversized=weight of oversize/(weight of oversize+weight of undersize)×100.
3. If the material's Saturation Capacity is totally unknown, a trial and error must be done to initially establish an indication as to where roughly the saturation point may lie. This is important to identify the spread of the 5 data point of AES paste:powder weight ratio later on as described above to quantify the Saturation Capacity. Weigh 2 different levels of AES paste in syringes. Each AES level is added to a new batch of pre-weighed powder as described above. A good example where one has acquired suitable estimate of the Saturation Capacity is when at least 1 point is below the saturation (<10% oversize) and the second data point is above saturation (>10% oversize).
4. Weigh 3 different amount of paste separately in addition to the first 2 data points used for initial estimation with paste quantities calculated as AES paste:powder ratio predefined in such manner that ideally the first 2 ratios will be below its saturation point, the third point close to its saturation point and the remaining 2 ratios are beyond its saturation point. Please refer to FIG. 1 for an example graph of the Saturation Capacity as generated by steps 3 and 4.
5. Plot the 5 data points with % oversize on the Y-axis and AES:Powder weight ratio on the X-axis. Using a least square curve fit, calculate the intersection of 10% oversize and solve for the AES:Weight Powder Ratio.

### Test 2: Structurant Residue Test

The Structurant Residue Test is used to measure the amount of residue associated with a structurant material, especially an insoluble or sparingly-soluble structurant. Such residues are relevant to the potential of incurring fabric residues as a result of washing. The principle of applicants′ Residue test follows that of published International Standard ISO 3262-19:2000, Section 8, “Determination of residue on sieve”. The method is adapted herein to suit a broader range of structurant materials applicable to the current invention.

Obtain a standard sieve consisting of a metal frame and wire mesh made from stainless steel, having a mesh size of 45 μm (e.g., ASTM 325 mesh) and frame diameter of about 200 to 250 mm. Obtain a 1000 mL laboratory beaker. Obtain a drying oven, capable of being maintained at about 105° C. (+/−2° C.). Obtain a suitable microbalance with precision to 0.01 g. Record the tare weight of the clean dry sieve.

Weigh out 20 g (+/−0.01 g) of structurant raw material into the beaker, then add 400 g (+/−1 g) of distilled water at about 20° C. (+/−2° C.), to the beaker and stir to break-up and disperse any lumps, then continue stirring for 15 minutes (for non-limiting example using a suitable stir plate with magnetic stir bar) until a suspension or solution is formed. Gradually empty the contents of the beaker into the sieve such that no liquid overflows the rim. The liquid passing through the screen is not retained. Rinse the beaker with an additional 400 g of distilled water, and pour the rinse water through the screen. Place the screen into the drying oven and let it remain until water is evaporated. Weigh the sieve including the dried residue on the screen, then subtract the mass of the clean dry sieve to determine the mass of residue on the screen. The residue factor is calculated as the residue mass/initial structurant raw material mass.

### Test 3: Dissolution Test

The Dissolution test is used to measure the amount of cleaning active dissolved in wash water from a particulate comprising the active, specifically how the amount dissolved changes with elapsed time following immersion of the particulate in water. In practice, a variety of analytical methods can be used to measure dissolution, depending on the specific active in question. A more general analytical method using two-phase titration is applicable to the broad range of anionic surfactants.

The two-phase titration method follows that of published International Standard ISO 2271: 1989. Determination of anionic-active matter by manual or mechanical direct two-phase titration procedure, with extra sampling procedures on top this method. The details of the method, as adapted to the current invention, are as follows. Weight 1.0 grams (+/−0.01 g) structured particle and then add it into a beaker that containing 1000 g (+/−1 g) of distilled water at about 20° C. (+/−2° C.), and stir. Then a 10 mL syringe is used to take out 6-8 mL solution from beaker every 15 seconds. The solution was immediately passed through a 0.45 μm PTFE filter and filtrate is collected into a small beaker. Pipet 5 mL of filtrate solution into a titration cylinder. Add 20 mL of acidified mixed indicator of bromide and disulfine blue solution from a dispenser and add a magnetic stirrer. Add 15 mL of chloroform from a dispenser. Titrate with the standardized Hyamine 0.00400 N solution whilst stirring vigorously (The mixed indicator and Hyamine were prepared and standardized according to the procedure described in the international standard ISO2711). Stir as vigorously as possible. Add Hyamine at a moderate rate until the upper layer begins to turn red. Continue to add Hyamine at a moderate rate reducing to dropwise addition as the red becomes less intense. When the top layer becomes grey, stop the stirrer and allow to settle. After separation of the layers, inspect the lower layer for endpoint detection. The endpoint is indicated when the lower chloroform layer changes from red to grey.

The characteristic dissolution time is defined as the time required to dissolve 63% of a sample's active surfactant, obtained by linear interpolation from dissolution data above and below the 63% threshold, where the percent dissolution at time=0 is defined as zero. The sampling frequency is every 15 seconds in the first 5 minutes as required, then every 30 seconds in the next 10 minutes as required, and then every 1 minute thereafter, as required to reach the 63% dissolution threshold.

### Test 4: Porosity Test

The Porosity Test is used to measure the relative volume of porosity contained within the internal structure of granular particulates, (i.e., intra-particle porosity). The principle of applicants′ Porosity Test follows that of published International Standard ISO 15901-01: Evaluation of pore size distribution and porosity of materials by mercury porosimetry and gas adsorption—Part 1: Mercury Porosimetry. Porosity falls into two categories: inter-particle (voids in-between granules) and intra-particle porosity (pores within granules). The current method is used to measure the intra-particle porosity. The details of the method, as adapted to the current invention, are as follows.
1. A sample of about 2 cm³ volume with particle size from 300 μm to 600 μm by sieve classification is loaded into the Penetrometer assembly having a suitable bulb and stem assembly to ensure greater than 25% and less than 75% stem volume usage over the pressure range specified in part 3. The sample assembly is then evacuated to remove gas from pores.
2. Dry nitrogen is introduced into the evacuated measuring cell in a controlled manner to increase the pressure (either in stages, continuously or by step-wise pressurisation) according to the proper equilibration conditions for mercury entering the pores and with precision required for the particular pores size range of interest, covering at least up to 0.2 MPa, corresponding to 6 μm pore size diameter. Pressure and corresponding volume of mercury intruded can be recorded either graphically or via a computer. When the maximum required pressure has been reached, the pressure is reduced to ambient and the sample holder is transferred to the high pressure unit.
3. In the high pressure unit, pressure is increased via intrusion of mercury (as a hydraulic fluid) by step-wise pressurisation according to the proper equilibration conditions for mercury entering the pores, with precision required for the particular pores size range of interest, covering at least up to 400 MPa, corresponding to 3 nm pore diameter. As a consequence, mercury is pressed into the pore system and the decreasing length of the mercury column is measured as a function of pressure. Pressure and corresponding volume of mercury intruded can be recorded via a computer.
4. The pressure exerted is inversely proportional to the clear width of the pore entrance. For pores of cylindrical shape the Washburn equation gives the relation between pressure and diameter: dₚ=−4γ cos θ/P, in which dₚ is pore size diameter, γ is surface tension of mercury [N·m⁻¹], θ is contact angle, and P is the intrusion pressure. Generally used values for surface tension and contact angle of mercury are 480 mN·m⁻¹ and 140°, respectively. Using the Washburn equation the pressure readings are converted to pore size diameter. The intruded volume related to sample mass as ordinate in dependence of the pore diameter as abscissa is plotted to give the pore volume distribution.

The cumulative pore volume distribution includes both interstitial and intra-particle porosity. Within the bounds of the current invention, the threshold intra-particle pore size has been determined using a differential distribution analysis: 30 μm is cut-off pore size; pores larger than 30 μm are considered as inter-particle; and pores smaller than 30 μm is considered intra-particle. The intra-particle porosity is calculated by intra-particle pore volume divided by the sum of the intra-particle pore volume and the solid volume of the particulate sample. The solid volume of the sample is the sample volume minus the total pore volume.

### Test 5: Structurant pH Test

This test method is used to measure the pH of the 5% structurant/water suspension, and is indicative of the relative acidity or alkalinity of the silica. The pH-value is measured by electrometry using a glass electrode in a pH-meter, for non-limiting example as described in ASTM test method D6739 (ASTM International, West Conshohocken, Pa.).

### Test 6: Physical Stability Test

The purpose of the physical stability test is to measure the change in flowability of granular detergent products or components thereof when the products or components are subjected to stressed temperature and humidity conditions. A baseline flowability is measured according to the Flowability Test as described below, using a control sample that is substantially equilibrated, for 24 hours in an open bowl, at conditions of about 30% relative humidity and temperature of about 22° C. The stressed flowability of an equivalent test sample, equilibrated for 24 hours in an open bowl at stressed conditions of 74% relative humidity and 32° C., is measured. The Physical Stability is calculated as the stressed flowability divided by the baseline flowability measurements.

### Test 7: Dispersion Profile Test

The Dispersion ProfileTest is used to measure the cleaning compositions′ ability to disperse into wash-water and then rapidly disintegrate to release cleaning actives into solution. It combines aspects of granular flow-ability, wetting and immersion with water, and physical disintegration of the product particles. The Dispersion Profile Test is used to measure the amount of residue associated with a cleaning composition finished product or granular component thereof, for example structured particles.

The principle of applicants′ Dispersion Profile test follows that of published International Standard ISO 3262-19:2000, Section 8, “Determination of residue on sieve”. The method is adapted herein to measure the rate of dispersion and disintegration of granules added to a controlled flow to water over a very short time, i.e., the “instant” dispersion and disintegration of the cleaning composition product.

Obtain 3 standard sieves consisting of a metal frame and wire mesh made from stainless steel, each having a mesh size of 250 μm (e.g., ASTM 60 mesh) and frame diameter of about 200 mm to 250 mm. Obtain 3 sets of magnetic stir-plates, stir bars, and laboratory beakers, each having a capacity of 3 L. Obtain a drying oven, capable of being maintained at about 150° C. (+/−2° C.). Obtain a suitable microbalance with precision to 0.01 g. Record the tare weights of each clean dry sieve.

Prepare a sufficient source of test wash-water, at least 18 L, having a hardness of about 10 to 15 grains per gallon (gpg). Obtain a representative bulk product sample of at least 135 g. The test consists of 3 replicates, each using 3 dispersion tests. A total of 9 product samples of 15 g each are required; weigh out 9 samples of 15 g each.

Prepare the 3 sets of stir plates, stir bars and beakers. Add 2 L of test wash-water into each beaker. Switch on the magnetic stir plates and adjust their speeds to make the height of water on the edge of each beaker rise up to about 150% of the static water fill height.

Add one 15 g product sample to each beaker, then stop the stir plate sharply at 20 seconds of elapsed time and pour the dispersions from the 3 beakers through one of the sieves without overflowing the rim of the sieve. The liquid passing through the screen is not retained. This is one replicate. Repeat this procedure three times to get three replicates, i.e., 3 sieves, each retaining residue of the test.

Place the 3 sieves in the drying oven at 150° C. until the water is evaporated, typically about 1 hour. Weigh each sieve including the dried residue on the screen, and then subtract the mass of the clean dry sieve to determine the mass of residue on the screen. The Dispersion Profile is calculated as the residue mass/initial product sample mass, represented as a percent of the initial product mass.

### Test 8: Flowability Test

The purpose of the flowability test is to measure the flowability of granular detergent products or components thereof. Flowability can be measured using a suitable uniaxial compression tester, for example, a smooth plastic cylinder of internal diameter 6.35 cm and length 15.9 cm is supported on a suitable base plate such that the assembly stands on the base plate with the axis of the smooth cylinder in a vertical orientation. The cylinder has a 0.65 cm diameter hole perpendicular to its axis, with the centre of the hole being 9.2 cm from the end opposite the base plate.

A metal pin is inserted through the hole and a smooth plastic sleeve of internal diameter 6.35 cm and length 15.25 cm is placed around the inner cylinder such that the sleeve can move freely up and down the cylinder and comes to rest on the metal pin. The space inside the sleeve is then filled (without tapping or excessive vibration) with the particulate such that the particulate heaps above the top of the sleeve, and is then scraped level with the top of the sleeve. A lid is placed on top of the sleeve and a consolidation mass of 5 Kg is placed on the lid. The lid mass is not to exceed 0.1 Kg. The consolidation stress is the sum of the lid and consolidation mass (in kilogram units, Kg), multiplied by gravitational acceleration (9.81 m/s²), divided by the end area of the cake (0.003167 m²), then divided by 1000 to give the consolidation stress in kilopascal units (kPa). The pin is then removed and the particulate is allowed to compact for 2 minutes. After 2 minutes the weight is removed, the sleeve is lowered to expose the compressed particulate cake with the lid remaining on top of the compressed particulate.

A metal probe attached to a force gauge capable of recording a maximum applied force is then lowered at 54 cm/min such that it contacts the centre of the lid and breaks the cake. Theunconfined yield stress is calculated as the maximum force required to break the cake, measuredin Newtons (N) plus the load of the lid [lid mass (Kg) times the gravitational constant (9.81 m/s²)], divided by the end area of the cake (0.003167 m²), then divided by 1000 to give the unconfined yield stress in kilopascal units (kPa). If the cake collapses under the weight of the lid, then the stress due to the weight of the lid is recorded as the unconfined yield stress.

The flowability is defined as the consolidation stress divided by the unconfined yield stress, according to the flowability classification by Jenike (Jenike, A. W., Gravity flow of bulk solids, University of Utah, Utah Engineering Experiment Station Bulletin 108, 1961). A flow ability >=10 is “free flowing”; flowability <10 and >=4 is “easy flowing”; flowability <4 and >=2 is “cohesive”; flowability <2 and >=1 is “very cohesive”; and flow ability <1 is “non flowing”.

### EXAMPLES

### Example 1

Process for Making a Structurant. The structurant of the current invention is formed by polymerization of silicate anions from aqueous solution, wherein an alkaline silicate is neutralized with an acid, both reactants added as aqueous solutions. Within this example, the term “relative molar” means the number of moles relative to the total molar amount of SiO₂ added to the synthesis.

In typical commercial silica processes, it is preferred to reach stoichiometric neutralization of alkali silicate and acid. In the current work, a less-than stoichiometric process may be used, retaining some alkali ions within the molecular structure of the amorphous colloidal silica. In a preferred embodiment, sulfuric acid is used as follows:

(ω·R)·(H₂O)+R(SiO₂)·Na₂O+A(H₂SO₄)→R(SiO₂)·(1−A)Na₂O+A(Na₂SO₄)+(ω·R+A)(H₂O)

where “A” is the amount of acid used in the reaction, relative to the stoichiometric ratio for complete neutralization, “R” is the silicate ratio, [Na₂O]/[SiO₂], in the feedstock solution and “ω” is the relative molar amount of water added to the system, i.e., the total number of moles of water added to the system relative to moles of SiO₂, including aqueous silicate solution, aqueous acid solution, and optionally any additional water used in the starting heel of batch reaction vessels.

In this example, “A” can be from about 0.6 to about 1.0, preferably from about 0.7 to 0.9. In a system with less-than stoichiometric neutralization (i.e., A<1), the balance of un-neutralized Na₂O is substantially retained in the amorphous silica phase. The molar ratio of [Na₂O]/[SiO₂] in the amorphous silica can be from 0 to about 0.14 or from about 0.02 to about 0.14.

In this example, the neutralization reaction is done in a batch process, starting with an aqueous heel comprising a dilute silicate solution, and then adding aqueous silicate and acid reactants. The relative molar water in the system can be partitioned across the silicate solution (β), acid solution (α) and the heel (χ), α+β+χ=ω.

The silicate ratio of the starting material, “R”, is preferably in the range from about 1.6 to 3.4, more preferably from about 2.4 to 3.3, most preferably from about 2.8 to 3.2.

The relative molar amount of total water in the neutralization system (ω) is preferably from about 20 to 100, more preferably from about 25 to 75, even more preferably from about 30 to 60, most preferably from about 32 to 50. The total molar amount of water is distributed across reactant solutions (acid and silicate), with the balance added to the starting heel of the batch reactor. The relative molar amount of water in the acid solution (α) is preferably from about 0.4 to 10, more preferably from about 0.8 to 8, most preferably from about 1 to 5. The relative molar amount of water in the silicate solution (β) is preferably from about 8 to 50, more preferably from about 10 to 30, most preferably from about 12 to 20. The balance amount of water is in the heel.

Preferably, both reactant solutions are heated, preferably between about 60° C. and 80° C., and the batch reactor is jacketed to maintain a temperature of about 80° C. and 90° C. The reactor has a impeller capable of making a gentle vortex within the liquid in the reaction vessel. The addition points of the silica and acid solutions are directed as different sections of the vortex, preferably about 180° apart. The addition of silicate and acid solutions is done slowly over the course of about 90 minutes. The rate of acid is adjusted to maintain a pH objective in the reactor of about 9.5 to 11.0, preferably about 10.2 to 10.8, as measured using a suitable pH probe. As the neutralization proceeds, forming Na₂SO₄, the remaining material's silicate ratio, [SiO₂]/[Na₂O], increases to about 6 after 10 to 20 minutes, and the suspension becomes noticeably turbid. While the silicate ratio plateaus at a value of about 6.5 to 8 during the remainder of the silicate addition, the salt concentration of Na₂SO₄ steadily increases. A viscosity increase in the stirred slurry may be observed as the salt concentration approaches about 0.15 molar, typically at about 60 minutes. At about 90 minutes the total amount of silicate stock addition is complete, yet only about 55 wt % to 60 wt % of the stoichiometric acid amount will have been added. At this time, a final amount of acid is added to achieve a desired pH endpoint in the slurry.

For example, for a desired endpoint of about 8.5, about 90% of the stoichiometric amount of acid is used. This is illustrated in the following table, for a batch made from the following: 65 Kg of 20% solids Silicate Stock having R=3.3; 22.6 Kg of 20% Sulfuric Acid Stock; and an 80 Kg starting heel consisting of an aqueous solution of 0.8% Silicate having R=3.3:

TABLE 1
Recipe for Making Structurant Compostion

| | mass added to reactor (Kg) | | | | | |
|---|---|---|---|---|---|---|
| | silicate | acid | | Molar | Molar | |
| time (m) | stock | stock | total | SiO₂:Na₂O | Na₂SO₄ | Comment |
| 0 | 0 | 0 | 80.00 | 3.3 | 0.000 | Starting heel, 80 Kg |
| 1 | 0.723 | 0.153 | 80.88 | 3.7 | 0.004 | Start silicate stock |
| 8 | 5.781 | 1.227 | 87.01 | 5.2 | 0.029 | addition at fixed |
| 15 | 10.840 | 2.301 | 93.14 | 5.9 | 0.050 | rate, adjust acid to |
| 25 | 18.067 | 3.835 | 101.90 | 6.5 | 0.077 | maintain (pH 10.5) |
| 45 | 32.520 | 6.904 | 119.42 | 6.9 | 0.118 | |
| 60 | 43.360 | 9.205 | 132.57 | 7.1 | 0.141 | |
| 80 | 57.814 | 12.273 | 150.09 | 7.3 | 0.166 | |
| 87 | 62.873 | 13.347 | 156.22 | 7.3 | 0.174 | Silicate addition |
| 90 | 65.041 | 21.819 | 166.86 | 25.2 | 0.267 | complete, add |
| 92 | 65.041 | 22.604 | 167.64 | 33.1 | 0.275 | balance of acid to |
| 95 | 65.041 | 22.604 | 167.64 | 33.1 | 0.275 | 90% stoichiometry |
| | | | | | | (pH ~8.5) |

The intermediate product of this reaction comprises aqueous slurry of colloidal silica particles having an amorphous molecular structure and an adjunct salt. In the example given in the above table, the total solids concentration is about 10.4% in the slurry. The colloidal silica particles may be aggregated, for example in a micro-gel structure; in the example above, the silica phase comprises about 62% of the solids, and the ratio of [Na₂O]:[SiO₂] within the silica is about 0.03. The adjunct salt may be dissolved in the aqueous solution and/or may be partially adsorbed into the colloidal silica structure, for example in a micro-gel; in the example above, the salt phase comprises about 38% of the solids. Optionally, some of the aqueous salt solution may be removed, for example using a filtration process, retaining a wet filter cake. The slurry or filter cake is subsequently dried, forming a product powder. When re-mixed with water in a suitably dilute system, the powder preferably has a significant degree of dispersion wherein colloidal silica aggregates can substantially disperse to a colloidal state. While not being bound by theory, it is expected that the dispersion of silica aggregates is facilitated by the adjunct salt present, especially salt that is intimately mixed within the colloidal silica structures.

The product powder preferably has from about 0% to 40% water, more preferably from about 2% to 20% water, most preferably from about 4% to 10% water retained after drying.

By adjusting the concentration of stock solutions and heel, the neutralization reaction can be adjusted to achieve a solids yield in the range of about 5 wt % to 25 wt % of the aqueous system, preferably from about 8 wt % to 20 wt %, more preferably from about 10 wt % to 18 wt %, most preferably from about 12 wt % to 16 wt % of the aqueous system.

The adjunct salt content of the product can be further adjusted by filtration or augmentation. In filtration, the slurry is processed through a filter press. A portion of the salt is removed in the filtrate; the remainder of the salt solution is imbibed within the silica filter-cake. The filter cake is then dried, for example using a spin-flash dryer, to produce the structurant powder. In augmentation, additional salt, preferably in the form of a concentrated or even saturated aqueous solution, is added to the slurry, increasing the concentration of salt in the aqueous phase; then the slurry is dried, for example using a spray-dryer, to produce the structurant powder.

### Example 2

### Assessed Properties of the Structurant

a) Structurant pH
The pH of the structurant prepared in accordance with Example 1 can be determined in accordance with the assay described in the Test Method section. In one example, the pH of the structurant powder is similar to the endpoint pH of the aqueous slurry intermediate described in Example 1.

b) Structurant Residue Factor
The residue factor of the structurant prepared in accordance with Example 1 can be determined in accordance with the assay described in the Test Method section.

c) Structurant Saturation Capacity
The Saturation Capacity of the structurant prepared accordance with Example 1 can be determined in accordance with the assay described in the Test Method section. In one example, the Saturation Capacity of a structurant powder with about 35 wt % adjunct salt is about 2.0. In another example, the Saturation Capacity of a structurant powder having about 20 wt % adjunct salt is about 2.2.

### Example 3

### Process for Making a Structured Agglomerate

A structured agglomerate can be prepared according to the following preferred method:
1. Obtain a suitable cleaning active raw material, preferably in a concentrated liquid or paste form.
2. Obtain a suitable structurant for the cleaning active. Optionally, the structurant may be micronized to form a fine powder by milling, grinding or a comminuting step with any apparatus known in the art for milling, grinding or comminuting of granular or particulate compositions. The structurant may be optionally combined with other active or inactive detergent powder material, including stabilizers as may be required by the cleaning active.
3. Combine the above materials plus any recycle materials in a mixing chamber to make structured particles. The mixing process involves contacting the structurant, cleaning active raw material and to achieve a substantially homogenous dispersion of the active with the structurant. The mixing chamber may be any apparatus known in the art for agglomeration, granulation, granular mixing or layering of granular or particulate compositions. Examples of suitable mixer granulators include, but are not limited to, dual-axis counter-rotating paddle mixers, high-shear horizontal-axis mixer granulators, vertical-axis mixer-granulators, and V-blenders with intensifier elements. Such mixers may be batch or continuous in operation. In one aspect, the mixing chamber is a medium to high shear mixer with a primary impeller having a tip speed of 0.5 to 50 meters/second, 1 to 25 meters/second, 1.5 to 10 meters/second, or even 2 to 5 meters/second. In another aspect, the binder addition is done by atomization of the binder using a nozzle, contacting the spray with the powder mixture. In another aspect, the mixing chamber is a ploughshare mixer with a chopper located between the ploughs. In another aspect, the binder is added adjacent to the chopper location. In another aspect, the mixing chamber is a dual-axis counter-rotating paddle mixer, for example as described in U.S. Publication No. 2007/0196502. In another aspect, the cleaning active raw material is added by top-spray in the central fluidized zone of the counter-rotating dual-axis paddle mixer. In another aspect, the cleaning active raw material is added upward into the converging flow zone between the counter-rotating paddle axes of the counter-rotating dual-axis paddle mixer. In another aspect, having a cleaning active raw material diluted with water, the particles may be at least partially dried concurrent with the mixing-granulation process.
4. Optionally, the particles may be at least partially dried in a subsequent drying process. In one aspect, the drying process is a fluidized bed drier.
5. Optionally, classifying the particles of step 4 to obtain particles with an acceptable particle size distribution, where any oversize or undersize materials may optionally be recycled to process step 3 above. The classification may be done with any apparatus known in the art for particulate classification, separation, screening or elutriation of particulate compositions. In one aspect, any oversize material may reduced in particle size before recycling by milling, grinding or comminuting with any apparatus known in the art for milling, grinding or comminuting of granular or particulate compositions. In another aspect, the product granules may be treated by screening out oversized particles using equipment such as a vibratory screener.
6. Optionally, the particles of step 5 may be used as a seed in a subsequent layering process to make a layered granule wherein structured particle comprises the seed of the layered granule. In one aspect, the layering process is described in U.S. Publication No. 2007/0196502. In another aspect, the layer may comprise additional detergent ingredients.
7. Optionally, a structured particulate comprising a seed and a structured layer may be prepared according to the process described above with the addition of a suitable seed particulate in step 3. In one aspect, the seed is at least 50 wt % of the structured particles produced in step 3. In another aspect, the seed has a median particle diameter of from about 150 microns to about 1700 microns, from about 200 microns to about 1200 microns, from about 250 microns to about 850 microns or even from about 300 microns to about 600 microns. In another aspect, the seed has a size distribution span of from about 1.0 to about 2.0, from about 1.05 to about 1.7, or even from about 1.1 to about 1.5. In another aspect, the structured particulate comprising a seed and a structured layer may be prepared in accordance with U.S. Publication No. 2007/0196502, wherein the layering powder comprises a suitable structurant and the binder comprises a suitable cleaning active. In another aspect, the seed may comprise additional detergent ingredients. Table 2 has detailed examples (3A-3F) of structured particle

TABLE 2
Sample Structured Particle Formulations

| | 3A | 3B | 3C | 3D | 3E | 3F | 3G |
|---|---|---|---|---|---|---|---|
| AExS, x = 1 to 3 | 35.0% | 45.0% | 55.0% | — | — | — | 9.0% |
| LAS | — | — | — | 40.0% | 55.0% | 65.0% | 32.0% |
| Structurant | 22.1% | 22.0% | 24.7% | 8.1% | 20.5% | 29.1% | 10.9% |
| powder | | | | | | | |
| Sodium carbonate | 39.0% | 28.9% | 15.9% | 49.9% | 21.5% | 4.2% | 45.7% |
| Moisture & misc. | 4.0% | 4.1% | 4.4% | 2.0% | 3.1% | 1.7% | 2.4% |
| Total | 100.0% | 100.0% | 100.0% | 100.0% | 100.0% | 100.0% | 100.0% |

3A) 70% AES paste binder, SC = 2.0, dense grade sodium carbonate, SR = 4.6
3B) 78% AES paste binder, SC = 2.2, light grade carbonate, SR = 2.7
3C) 78% AES paste binder, SC = 2.5, micronized light carbonate, SR = 1.2
3D) binder comprising a mix of HLAS + NaOH(50%, aq), 32% of stoichiometric LAS neutralization, SC = 2.2, micronized light carbonate, SR = 5.2
3E) binder comprising a mix of HLAS + NaOH(50%, aq), 77% of stoichiometric LAS neutralization, SC = 2.5, micronized light carbonate, SR = 1.6
3F) 78% LAS paste binder, SC = 2.5, micronized light carbonate
3G) layered structure, 10% layer of “3B” composition on 90% “3D” seed
SC) is Saturation Capacity of structurant powder
SR) is the stabilizer ratio, molar ratio of sodium carbonate to surfactant
AES refers to sodium alkylethoxysulfate wherein the average degree of alkoxylation, preferably ethyoxylation, is preferably in the range of about 0.1 to 5.0, preferably from about 1.0 to 3.0.
LAS refers to sodium-neutralized linear-alkylbenzene-sulphonate.
HLAS refers to linear-alkylbenzene-sulphonic acid.

### Example 4

### Properties of the Structured Particle

a) Dispersion Profile
The dispersion profile of the structured particle prepared according to Example 3 can be determined in accordance with the Dispersion Profile Test described in the Test Method section.

b) Porosity
The porosity of the structured particle prepared according to Example 3 can be determined in accordance with the assay described in the Test Method section. In one example, the structured particle 3B has intra-granule porosity of about 23%.

c) Dissolution Profile of the Cleaning Active
The dissolution time of the cleaning active comprised by the structured particle prepared in accordance with Example 3 can be determined in accordance with the assay described in the Test Method section. In one example, the structured particle 3A has a dissolution time of about 70 seconds; the structured particle 3B has a dissolution time of about 45 seconds; and the structured particle 3C has a dissolution time of less than 30 seconds.

d) Flowability and Physical Stability
The flowability of the structured particle prepared in accordance with Example 3 can be determined in accordance with the assay described in the Test Method section. The physical stability of the structured particle prepared in accordance with Example 3 can be determined in accordance with the assay described in the Test Method section. In one example, the structured particle 3A, described in Example 3, has a baseline flowability of about 6.9 and a stressed flowability of about 6.1; its physical stability is about 0.88. A comparision particle made with the same AES active, but without the structurant may have a similar baseline flowability, but its stressed flowability is less than 3; its physical stability is less than 0.5.

### Example 5

### Making the Granular Detergent Product

Suitable granular detergent compositions designed for use in washing machines or hand washing processes. The compositions are made by combining the listed ingredients in the listed proportions (weight % of active material except where noted otherwise).

TABLE 3
Examples of Granular Detergent Product Formulation Ranges

| Ingredient | Amount (in wt %) |
|---|---|
| Anionic detersive surfactant (such as alkyl benzene | from 8 wt % to 20 wt % |
| sulphonate, alkyl ethoxylated sulphate and mixtures thereof) | |
| Non-ionic detersive surfactant (such as alkyl ethoxylated | from 0 wt % to 4 wt % |
| alcohol) | |
| Cationic detersive surfactant (such as quaternary ammonium | from 0 wt % to 4 wt % |
| compounds) | |
| Other detersive surfactant (such as zwiterionic detersive | from 0 wt % to 4 wt % |
| surfactants, amphoteric surfactants and mixtures thereof) | |
| Carboxylate polymer (such as co-polymers of maleic acid and | from 1 wt % to 5 wt % |
| acrylic acid) | |
| Polyethylene glycol polymer (such as a polyethylene glycol | from 0 wt % to 4 wt % |
| polymer comprising poly vinyl acetate side chains) | |
| Polyester soil release polymer (such as Repel-o-tex and/or | from 0 wt % to 2 wt % |
| Texcare polymers) | |
| Cellulosic polymer (such as carboxymethyl cellulose, methyl | from 0 wt % to 2 wt % |
| cellulose and combinations thereof) | |
| Other polymer (such as amine polymers, dye transfer | from 0 wt % to 4 wt % |
| inhibitor polymers, hexamethylenediamine derivative | |
| polymers, and mixtures thereof) | |
| Zeolite builder and phosphate builder (such as zeolite 4A | from 0 wt % to 10 wt % |
| and/or sodium tripolyphosphate) | |
| Other builder (such as sodium citrate and/or citric acid) | from 0 wt % to 5 wt % |
| Carbonate salt (such as sodium carbonate and/or sodium | from 10 wt % to 35 wt % |
| bicarbonate) | |
| Silicate salt (such as sodium silicate) | from 0 wt % to 15 wt % |
| Filler (such as sodium sulphate and/or bio-fillers) | from 10 wt % to 60 wt % |
| Source of available oxygen (such as sodium percarbonate) | from 0 wt % to 30 wt % |
| Bleach activator (such as tetraacetylethylene diamine (TAED) | from 0 wt % to 10 wt % |
| and/or nonanoyloxybenzenesulphonate (NOBS) | |
| Bleach catalyst (such as oxaziridinium-based bleach catalyst | from 0 wt % to |
| and/or transition metal bleach catalyst) | 0.1 wt % |
| Other bleach (such as reducing bleach and/or pre-formed | from 0 wt % to |
| peracid) | 10 wt % |
| Chelant (such as ethylenediamine-N′N′-disuccinic acid | from 0.2 wt % to 2 wt % |
| (EDDS) and/or hydroxyethane diphosphonic acid (HEDP) | |
| Photobleach (such as zinc and/or aluminium sulphonated | from 0 wt % to 0.1 wt % |
| phthalocyanine) | |
| Hueing agent (such as direct violet 99, acid red 52, acid blue | from 0 wt % to 1 wt % |
| 80, direct violet 9, solvent violet 13 and any combination | |
| thereof) | |
| Brightener (such as brightener 15 and/or brightener 49) | from 0 wt % to 0.4 wt % |
| Protease* (such as Savinase ®, Savinase ® Ultra, Purafect ®, | from 0 wt % to 0.4 wt % |
| FN3, FN4 and any combination thereof) | |
| Amylase* (such as Termamyl ®, Termamyl ® ultra, | from 0 wt % to 0.2 wt % |
| Natalase ®, Optisize, Stainzyme ®, Stainzyme ® Plus and any | |
| combination thereof) | |
| Cellulase* (such as Carezyme ® and/or Celluclean ®) | from 0 wt % to 0.2 wt % |
| Lipase* (such as Lipex ®, Lipolex ®, Lipoclean ® and any | from 0 wt % to 1 wt % |
| combination thereof) | |
| Other enzyme* (such as xyloglucanase, cutinase, pectate | from 0 wt % to 2 wt % |
| lyase, mannanase, bleaching enzyme) | |
| Fabric softener (such as montmorillonite clay and/or | from 0 wt % to 10 wt % |
| polydimethylsiloxane (PDMS) | |
| Flocculant (such as polyethylene oxide) | from 0 wt % to 1 wt % |
| Suds suppressor (such as silicone and/or fatty acid) | from 0 wt % to 0.1 wt % |
| Perfume (such as perfume microcapsule, spray-on perfume, | from 0 wt % to 2 wt % |
| starch encapsulated perfume accords, perfume loaded zeolite, | |
| and any combination thereof) | |
| Aesthetics (such as visually contrasting aesthetic particles) | from 0 wt % to 10 wt % |
| Miscellaneous | balance |

*All enzyme levels expressed as rug active enzyme protein per 100 g detergent composition.

Examples of cleaning product formulations, 5A-5F, made using the structured particles of Example 3 (3A-3F) are shown in table 4. The base granule is typically spray-dried or agglomerated; its composition may comprise cleaning active, such as, LAS surfactant, detersive polymer, chelant, sodium silicate, sodium carbonate and sodium sulfate. The use of structured particles in product formulation may allow simplification of the base granule. The other admix ingredients may comprise fillers and/or other functional cleaning actives such as bleach actives, brightener, enzyme, suds suppressor, hueing dye, perfume, aesthetic particles and/or miscellaneous ingredients.

TABLE 4
Example Cleaning Product Formulations

| | 5A | 5B | 5C | 5D | 5E | 5F |
|---|---|---|---|---|---|---|
| LAS Surfactant | 14.2% | 15.8% | 15.6% | 12.4% | 14.6% | 14.0% |
| AES Surfactant | 1.5% | 1.0% | 0.0% | 1.1% | 1.5% | 1.0% |
| Other | 0.9% | 0.9% | 0.0% | 1.7% | 0.9% | 1.0% |
| Surfactant | | | | | | |
| Polymer | 2.2% | 2.0% | 1.4% | 3.9% | 1.7% | 1.1% |
| System | | | | | | |
| Sodium | 18.0% | 16.8% | 12.6% | 23.7% | 17.4% | 13.6% |
| Carbonate | | | | | | |
| Sodium Silicate | 9.2% | 9.6% | 10.1% | 7.3% | 8.0% | 6.3% |
| Sodium Sulfate | 38.0% | 45.0% | 52.0% | 12.4% | 45.0% | 56.4% |
| Bleach System | 7.6% | 0.0% | 0.0% | 30.9% | 2.9% | 0.0% |
| Enzyme | 0.8% | 0.4% | 0.3% | 0.8% | 0.7% | 0.5% |
| System | | | | | | |
| Other Actives | 7.6% | 8.5% | 8.0% | 5.9% | 7.3% | 6.1% |
| and Misc. | | | | | | |
| Total | 100.0% | 100.0% | 100.0% | 100.0% | 100.0% | 100.0% |

Making the above cleaning product formulations using the structured particles 3A-3G, as described in above Example 3. Alternative combinations of structured particles and base granules are shown for 5A, 5D and 5F.

TABLE 5
Example of Alternative Structure Particles

| Product | Structure Particle | Base Granule | Other Admix | Total |
|---|---|---|---|---|
| 5A-i | 3A: 4.2% & 3D: 19.8% | 53.0% | 23.0% | 100% |
| 5A-ii | 3B: 3.3% & 3D: 19.8% | 53.9% | 23.0% | 100% |
| 5A-iii | 3B: 3.3% | 73.7% | 23.0% | 100% |
| 5A-iv | 3C: 2.7% & 3D: 19.8% | 54.5% | 23.0% | 100% |
| 5A-v | 3E: 14.4% & 3C: 2.7% | 59.9% | 23.0% | 100% |
| 5A-vi | 3F: 12.2% & 3C: 2.7% | 62.1% | 23.0% | 100% |
| 5B | 3B: 2.2% & 3D: 19.8% | 66.0% | 12.0% | 100% |
| 5C | 3D: 19.8% | 65.2% | 15.0% | 100% |
| 5D-i | 3A: 3.0% & 3D: 19.8% | 40.2% | 37.0% | 100% |
| 5D-ii | 3B: 2.3% & 3D: 19.8% | 40.9% | 37.0% | 100% |
| 5D-iii | 3C: 2.0% & 3D: 19.8% | 41.2% | 37.0% | 100% |
| 5D-iv | 3C: 2.0% & 3E: 14.4% | 46.6% | 37.0% | 100% |
| 5D-v | 3G: 23.9% | 39.1% | 37.0% | 100% |
| 5E | 3B: 3.2% & 3D: 19.8% | 56.0% | 21.0% | 100% |
| 5F-i | 3B: 2.1% & 3D: 19.8% | 61.1% | 17.0% | 100% |
| 5F-ii | 3B: 2.1% | 80.9% | 17.0% | 100% |

Surfactant ingredients can be obtained from BASF, Ludwigshafen, Germany (Lutensol®); Shell Chemicals, London, UK; Stepan, Northfield, Ill., USA; Huntsman, Huntsman, Salt Lake City, Utah, USA; Clariant, Sulzbach, Germany (Praepagen®).

Sodium tripolyphosphate can be obtained from Rhodia, Paris, France.

Zeolite can be obtained from Industrial Zeolite (UK) Ltd, Grays, Essex, UK.

Citric acid and sodium citrate can be obtained from Jungbunzlauer, Basel, Switzerland.

NOBS is sodium nonanoyloxybenzenesulfonate, supplied by Eastman, Batesville, Ark., USA.

TAED is tetraacetylethylenediamine, supplied under the Peractive® brand name by Clariant GmbH, Sulzbach, Germany.

Sodium carbonate and sodium bicarbonate can be obtained from Solvay, Brussels, Belgium.

Polyacrylate, polyacrylate/maleate copolymers can be obtained from BASF, Ludwigshafen, Germany.

Repel-o-tex can be obtained from Rhodia, Paris, France.

Texcare can be obtained from Clariant, Sulzbach, Germany.

Sodium percarbonate and sodium carbonate can be obtained from Solvay, Houston, Tex., USA.

Na salt of Ethylenediamine-N,N′-disuccinic acid, (S,S) isomer (EDDS) was supplied by Octel, Ellesmere Port, UK.

Hydroxyethane di phosphonate (HEDP) was supplied by Dow Chemical, Midland, Mich., USA.

Enzymes Savinase®, Savinase® Ultra, Stainzyme® Plus, Lipex®, Lipolex®, Lipoclean®, Celluclean®, Carezyme®, Natalase®, Stainzyme®, Stainzyme® Plus, Termamyl®, Termamyl® ultra, and Mannaway® can be obtained from Novozymes, Bagsvaerd, Denmark.

Enzymes Purafect®, FN3, FN4 and Optisize can be obtained from Genencor International Inc., Palo Alto, Calif., US.

Direct violet 9 and 99 can be obtained from BASF DE, Ludwigshafen, Germany.

Solvent violet 13 can be obtained from Ningbo Lixing Chemical Co., Ltd. Ningbo, Zhejiang, China.

Brighteners can be obtained from Ciba Specialty Chemicals, Basel, Switzerland.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition, preferably a granular detergent product, comprising a structured particle, wherein the structured particle comprises;
(a) at least 10 wt % of a cleaning active selected from the group comprising of: a surfactant, a chelant, a polymer, an enzyme, a bleaching active, a perfume, a hueing agent, a silicone; and any mixture thereof, preferably a surfactant, a chelant and a polymer; and
(b) from about 1 wt % to about 40 wt % of a structurant, wherein the structurant comprises:
i. from about 55 wt % to about 90 wt % of a silica having a [Na₂O]/[SiO₂] molar ratio of, from about 0.02 to about 0.14, preferably from about 0.02 to about 0.10, more preferably from about 0.04 to 0.08; and
ii. preferably at least about 10 wt % of an adjunct salt;
wherein the structurant has a hydrated particle size distribution such that no more than 30 wt % of the structurant has a hydrated particle size greater than 45 micrometers according to the Structurant Residue Test Method described herein, and a tapped bulk density of, from about 200 g/L to about 300 g/L, preferably from about 200 g/L to about 280 g/L, more preferably from about 220 g/L to about 280 g/L.

2. The cleaning composition according to claim 1, wherein the structured particle has a dispersion profile having less than 20% residue, preferably less than 10% residue, more preferably less than 5% residue, and even more preferably less than 2% residue according to the Dispersion Profile Test described herein.

3. The cleaning composition according to claim 1 or 2, wherein the structured particle is a structured agglomerate.

4. The cleaning composition according to any preceding claim, wherein the structured particle has a porosity of from about 5 volume % to about 30 volume %, preferably from about 10 volume % to about 25 volume %, as calculated by the Porosity Test as described herein.

5. The cleaning composition according to any preceding claim, wherein the cleaning active comprised by the structured particle is a surfactant, and the structurant of claim 1 has a pH of from about 8.5 to about 11.0, preferably from about 9.0 to about 10.5, and even more preferably from about 9.5 to about 10.0, according to the Structurant pH Test described herein.

6. The cleaning composition according to any preceding claim, wherein the cleaning active comprised by the structured particle is substantially soluble at or below about 20° C., preferably at or below about 15° C., and more preferably at or below about 10° C.

7. The cleaning composition according to any preceding claim, wherein the cleaning active comprised by the structured particle is a surfactant, and wherein the structured particle additionally comprises an alkali metal stabilizer, the alkali metal stabilizer is sodium hydroxide, and wherein the molar ratio of sodium hydroxide to surfactant is from about 0.05 to about 0.5.

8. The cleaning composition according to any preceding claim, wherein the cleaning active comprised by the structured particle is a surfactant, and wherein the structured particle additionally comprises an alkali metal stabilizer, the alkali metal stabilizer is sodium carbonate, and wherein the molar ratio of the sodium carbonate to the surfactant is from about 1 to about 10.

9. The cleaning composition according to any preceding claim, wherein the structurant has an oil absorbency of at least 170 g/100 g.

10. The cleaning composition according to any preceding claim, wherein the structurant has a Saturation Capacity of at least about 1.7 g/g as determined by a Saturation Capacity Test as described herein.

11. The cleaning composition according to any preceding claim, wherein the cleaning active comprised by the structured particle is an alkylethoxysulphate anionic detersive surfactant.

12. The cleaning composition according to any preceding claims, wherein the cleaning active comprised by the structured particle is selected from the group consisting of: methylglycine diacetic (MGDA); glutamic acid diacetic acid (GLDA); and any combination thereof.

13. The cleaning composition according to any preceding claim, wherein the cleaning active comprised by the structured particle is an anionic surfactant, and wherein the characteristic dissolution time of the cleaning active is less than about 120 seconds as measured by a Dissolution Test as described herein.

14. The cleaning composition according to any preceding claim, wherein the structured particle has a Physical Stability greater than about 0.6 as measured by a Physical Stability Test as described herein.

15. The cleaning composition according to any preceding claim, wherein the structured particle has a flowability greater than 4 as measured by a Flowability Test as described herein.

16. The cleaning composition according to claim 1, wherein the cleaning composition comprises a detersive surfactant, wherein the detersive surfactant comprises:
(i) alkyl alkoxylated sulphate anionic detersive surfactant having an average degree of alkoxylation of from 0.5 to 5; and/or
(ii) predominantly C₁₂ alkyl sulphate anionic detersive surfactant; and/or
(iii) less than 25% non-ionic detersive surfactant.

17. The cleaning composition according to claim 1, wherein the cleaning composition comprises a clay and a soil removal/anti-redeposition agent selected from the group consisting of:
(a) random graft co-polymers comprising:
(i) hydrophilic backbone comprising polyethylene glycol; and
(ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof;
(b) cellulosic polymers having a degree of substitution (DS) of from 0.01 to 0.99 and a degree of blockiness (DB) such that either DS+DB is at least 1.00 or DB+2DS-DS² is at least 1.20;
(c) co-polymers comprising:
(i) from 50 to less than 98 wt % structural units derived from one or more monomers comprising carboxyl groups;
(ii) from 1 to less than 49 wt % structural units derived from one or more monomers comprising sulfonate moieties; and
(iii) from 1 to 49 wt % structural units derived from one or more types of monomers selected from ether bond-containing monomers represented by formulas (I) and (II): 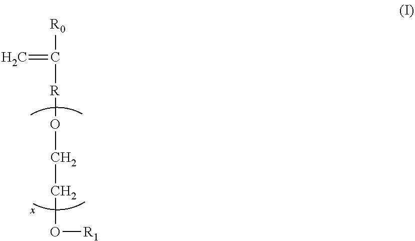
wherein in formula (I), Rₒ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group; 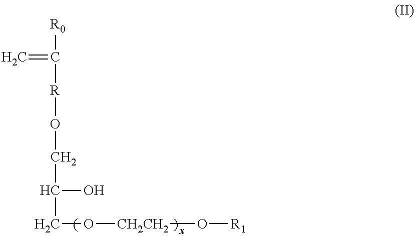
in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group;
(d) polyester soil release polymers having a structure according to one of the following structures (III), (IV) or (V):
—[(OCHR¹—CHR²)ₐ—O—OC—Ar—CO—]_{d} (III)
—[(OCHR³—CHR⁴)_{b}—O—OC-sAr—CO—]ₑ (IV)
—[(OCHR⁵—CHR⁶)_{c}—OR⁷]_{f} (V)
wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetra-alkylammonium wherein the alkyl groups are C₁-C₁₈ alkyl or C₂-C₁₀ hydroxyalkyl, or any mixture thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl,
or a cycloalkyl group with 5 to 9 carbon atoms, or a C₈-C₃₀ aryl group, or a C₆-C₃₀ arylalkyl group; and
(e) any combination thereof.

18. The cleaning composition according to claim 1, wherein the cleaning composition comprises an oxaziridinium-based bleach catalyst having the formula (VI): 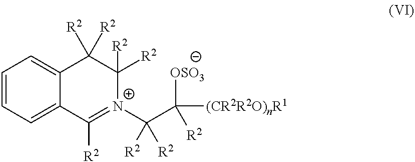
wherein: R¹ is selected from the group consisting of: H, a branched alkyl group containing from 3 to 24 carbons, and a linear alkyl group containing from 1 to 24 carbons; R² is independently selected from the group consisting of: H, a branched alkyl group comprising from 3 to 12 carbons, and a linear alkyl group comprising from 1 to 12 carbons; and n is an integer from 0 to 1.

19. The cleaning composition according to claim 1, wherein the cleaning composition comprises a C.I. fluorescent brightener 260 having the following structure (VII): 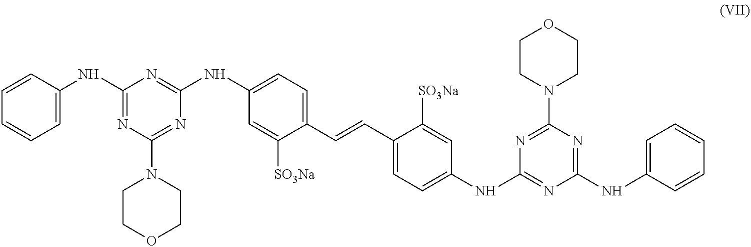
wherein the C.I. fluorescent brightener 260 is either:
predominantly in alpha-crystalline form; or
predominantly in beta-crystalline form and having a weight average primary particle size of from 3 to 30 micrometers.

20. The cleaning composition according to claim 1, wherein the cleaning composition comprises an enzyme selected from the group consisting of:
(a) a variant of thermomyces lanuginosa lipase having >90% identity with the wild type amino acid and comprises substitution(s) at T231 and/or N233;
(b) a cleaning cellulase belonging to Glycosyl Hydrolase family 45;
(c) a variant of AA560 alpha amylase endogenous to Bacillus sp. DSM 12649 having:
(i) mutations at one or more of positions 9, 26, 149. 182, 186, 202, 257, 295, 299, 323, 339 and 345; and
(ii) one or more substitutions and/or deletions in the following positions: 118, 183, 184, 195, 320 and 458; and
(d) any combination thereof.

21. The cleaning composition according to claim 1, wherein the cleaning composition is substantially free of zeolite builder, and wherein the cleaning composition is substantially free of phosphate builder.

22. A process of making the agglomerate of claim 3, wherein the process comprises:
a. adding powder raw ingredients into a mixer-granulator wherein the powder raw ingredients comprises:
i. a suitable structurant according to claim 1;
ii. optionally, a stabilizer powder; and
iii. optionally, fines recycled from the granulation process;
b. adding active raw ingredients into the mixer-granulator in the form of a liquid solution, suspension or paste binder;
c. running the mixer-granulator to provide a suitable mixing flow field for agglomeration of the fine powder raw ingredients with the binder;
d. optionally, drying the agglomerates to remove moisture that may be present in excess of 10 wt %, preferably in excess of 5 wt %;
e. optionally, removing any oversize agglomerates and recycling via a grinder; and
f. optionally, removing any fines and recycling the fines to the mixer-granulator, as described in step (a).

23. The process according to claim 22, wherein the structurant comprises:
a. from about 55 wt % to about 90 wt % silica having a [Na₂O]/[SiO₂] molar ratio of from about 0.02 to about 0.14, preferably from about 0.02 to about 0.10, more preferably from about 0.04 to 0.08; and
b. preferably at least about 15 wt % adjunct salt;
wherein the structurant has a tapped bulk density of from about 200 g/L, to about 300 g/L, preferably from about 200 g/L to about 280 g/L, more preferably from about 220 g/L to about 280 g/L.

24. The process according to claim 22, wherein the mixer-granulator is a dual-axis counter-rotating paddle mixer, wherein the binder is injected upward from the bottom of the mixer into the converging flow zone between the counter-rotating paddles, and paddles lifting the mixture upward in the converging flow zone.

25. A cleaning composition, preferably a granular detergent product, comprising a structured particle that is in the form of an agglomerate made by a process of any claims 22 to 24.
